(19) United States
(12) Patent Application Publication
(10) Pub. No.: US 2022/0244717 A1
(43) Pub. Date: Aug. 4, 2022

(54) Method for Porcessing Motion Signal, Electronic Device and Medium

(71) Applicant: Telefonaktiebolaget LM Ericsson (publ), Stockholm (SE)

(72) Inventor: Ning Zhang, Beijing (CN)

(21) Appl. No.: 17/616,405

(22) PCT Filed: Jun. 5, 2020
(86) PCT No.: PCT/CN2020/094717

§ 371 Date: Dec. 3, 2021

(30) Foreign Application Priority Data
Jun. 6, 2019 (CN) 2019 10492778.1

(51) Int. Cl. G05B 23/02; G06K 9/00; G06K 9/62

(52) U.S. Cl. CPC G05B 23/0221; G06K 9/6288; G06K 9/00536

(57) ABSTRACT

Disclosed are a method for processing a motion signal, an electronic device, and a medium. The method for processing a motion signal includes: obtaining a motion signal sensed by a motion sensor associated with a device (S201), the motion signal representing the motion of the device caused by an external object; and identifying an external object category of the external object that is the cause of the motion, using a motion identification algorithm, based on the motion signal (S203), wherein the motion identification algorithm is based on a plurality of motion models that respectively correspond to a plurality of external object categories.

### TECHNICAL FIELD

The present disclosure relates to a method for processing a motion signal, an electronic device, and a medium, and more particularly, to a method for processing a motion signal associated with a device, a method for providing a tactile prompt for a received communication, an electronic device, and a medium.

### BACKGROUND

In the related art, motion sensors are used to sense the motion of machining devices, engine devices, or the like. Machining devices or engine devices will make significant mechanical motions during operation, and failures of components of these devices may cause status of mechanical motions being abnormal. Therefore, sensing the motion status of these devices via motion sensors can assist determining the possible failures in the devices. This related technology is mainly used for devices that make significant mechanical motion during normal operation. The sensed motion is the motion made by a device itself, and the sensed abnormal motion status indicates that the device already has failures.

The method described in this section is not necessarily the method already conceived or utilized. Unless otherwise stated, it should not be assumed that any method described in this section is considered as the prior art simply because it is included in this section. Similarly, unless otherwise stated, the problems mentioned in this section should not be considered as identified in any prior art.

### SUMMARY

According to an aspect of the present disclosure, there is provided a method for processing a motion signal, including: obtaining a motion signal sensed by a motion sensor associated with a device, the motion signal representing a motion of the device caused by an external object; and identifying the external object category of the external object that is the cause of the motion, using a motion identification algorithm, based on the motion signal, wherein the motion identification algorithm is based on a plurality of motion models corresponding to a plurality of external object categories, respectively.

According to another aspect of the present disclosure, there is provided a method for processing a motion signal, including: obtaining a motion signal sensed by a motion sensor associated with a device, the motion signal representing a motion of the device caused by an external object; increamenting a count value of a counter, in response to determining that the motion signal satisfies a predetermined condition; and transmitting a message indicating that the device needs to be maintained, in response to the count value of the counter reaching a threshold count value.

According to yet another aspect of the present disclosure, there is provided a method for processing a motion signal, including: obtaining a first motion signal and a first additional signal from a first electronic device, the first motion signal being a motion signal sensed by a motion sensor associated with a first device, the first additional signal being an additional signal near the first device acquired by the additional sensor; obtaining a first external object category, the first external object category being an external object category of an first external object shown in the first additional signal; updating the first motion model corresponding to the first external object category, based on the first motion signal and the first external object category, if there is a first motion model corresponding to the first external object category; creating a first motion model corresponding to the first external object category, based on the first motion signal and the first external object category, if there is no first motion model corresponding to the first external object category; and enabling the first electronic device and a second electronic device different from the first electronic device to obtain the first motion model.

According to yet another aspect of the present disclosure, there is provided a method for providing a tactile prompt for a received communication, including: receiving a communication via a mobile phone; causing a first device to output a tactile prompt, in response to an occurrence of a first communication event; causing a second device different from the first device to output a tactile prompt, in response to an occurrence of a second communication event, wherein at least one of the first device and the second device is different from the mobile phone.

According to yet another aspect of the present disclosure, there is provided a method for providing a tactile prompt for a received communication, including: outputting a tactile prompt for a first communication in a first tactile prompt manner, in response to receiving a first communication from a first communication address; receiving a second communication from a second communication address, after receiving the first communication; outputting a tactile prompt for the second communication in a second tactile prompt manner different from the first tactile prompt manner, if the second communication address is the same as or associated with the first communication address, a user does not respond to the first communication, and an interval between the second communication and the first communication is less than a first predetermined period of time.

According to yet another aspect of the present disclosure, there is provided an electronic device including: a processor; and a memory configured to store a computer program, the computer program including computer readable instructions, which when executed by the processor, cause the processor to perform any of the methods as described previously.

According to yet another aspect of the present disclosure, there is provided a computer readable storage medium storing a computer program, the computer program including computer readable instructions, which when executed by the processor, cause the processor performs any of the methods as described previously.

According to the technical solution of the present disclosure, it is possible to timely process and effectively use a device motion caused by an external object. Further features and advantages of the present disclosure will become clear from the exemplary embodiments described below in conjunction with the drawings.

### BRIEF DESCRIPTION OF THE DRAWINGS

The drawings exemplarily show the embodiments and constitute a part of the specification, and together with the textual description of the specification are used to explain exemplary implementations of the embodiments. The illustrated embodiments are for illustrative purposes only and do not limit the scope of the claims. In all drawings, the identical reference numerals refer to similar or identical elements.

FIG. 1 is a schematic structural block diagram illustrating a system according to some exemplary embodiments of the present disclosure;

FIG. 2 is a flowchart illustrating a method for processing a motion signal according to some exemplary embodiments of the present disclosure;

FIG. 3 is a schematic diagram illustrating a motion identification algorithm according to some exemplary embodiments of the present disclosure;

FIG. 4 is a diagram illustrating an example of data related to an external object category according to some exemplary embodiments of the present disclosure;

FIG. 5 is a flowchart illustrating a method for processing a motion signal according to some exemplary embodiments of the present disclosure;

FIG. 6 (a), FIG. 6 (b), and FIG. 6 (c) are flowcharts illustrating a method for processing a motion signal according to some exemplary embodiments of the present disclosure;

FIG. 7 is a flowchart illustrating a method related to a confidence score of a model according to some exemplary embodiments of the present disclosure;

FIG. 8 is a schematic diagram illustrating an example of frequency domain signals of motion signals of different external objects according to some exemplary embodiments of the present disclosure;

FIG. 9 is a diagram illustrating an example of a correspondence relationship between tactile input patterns and user information according to some exemplary embodiments of the present disclosure;

FIG. 10 is a schematic diagram illustrating a remote computer and a database according to some exemplary embodiments of the present disclosure;

FIG. 11 is a flowchart illustrating a method for processing a motion signal by an electronic device and a remote computer according to some exemplary embodiments of the present disclosure;

FIG. 12 and FIG. 13 are structural block diagrams illustrating an electronic device according to some exemplary embodiments of the present disclosure;

FIG. 14 is a diagram illustrating an example of a correspondence relationship between a communication source and a device that outputs a tactile prompt according to some exemplary embodiments of the present disclosure;

FIG. 15 is a flowchart illustrating a method for providing a tactile prompt for a received communication according to some exemplary embodiments of the present disclosure; and

FIG. 16 is a structural block diagram illustrating an exemplary computing device that can be applied to exemplary embodiments of the present disclosure.

### DETAILED DESCRIPTION

In the present disclosure, unless otherwise stated, the use of the terms “first”, “second”, etc. to describe various elements is not intended to limit the positional relationship, timing relationship, or importance relationship of these elements, but only to distinguish one element from another. In some examples, a first element and a second element may refer to the same instance of the element, and in some cases, based on the contextual description, they may also refer to different instances.

The terminology used in the description of the various described examples in the present disclosure is for the purpose of describing specific examples only and is not intended to be limiting. Unless otherwise explicitly stated in the context, if the number of elements is not specifically limited, there may be one or more said element. In addition, the term “and/or” as used in the present disclosure covers any one or all of possible combinations of the listed items.

For a device in a complex environment, if an object outside the device (that is, an external object) in the environment can cause a mechanical motion, such mechanical motion may have a negative impact on the device. For example, for an electrical device such as a base station device, a high-voltage power device, a control cabinet, a monitoring device, etc., or a non-electrical device such as an entertainment facility, a mechanical instrument or meter, etc., in outdoor or complex work area, animals appearing in the vicinity (e.g., large animals, such as bears) may damage the device by shaking or impacting, and some lawbreakers may also damage the device for various purposes by kicking, hitting, etc. After being damaged one or more times, the device may have failures and cannot work. In addition, for some devices that contain relatively delicate or fragile components, external objects such as heavy trucks, subways passing by, or aircrafts taking off and landing in the vicinity can also cause the vibration of the devices. Although a vibration with low amplitude or power does not necessarily results in a device failure in a short period of time, the accumulation of vibrations may cause the device to work poorly or even malfunction.

In many cases, these devices are located outdoors or in inaccessible areas, away from the maintenance person. In addition, even for devices of the same model and specifications, if they are located in different areas, the devices may be subjected to different degrees of motion caused by different categories of external objects. In this case, it may not be known to the maintenance person when a device has failed. However, if the maintenance person frequently overhauls the devices, unnecessary waste of manpower may be caused.

The present disclosure provides a method for processing a motion signal. According to various exemplary methods of the present disclosure, a device motion caused by an external object outside a device can be sensed, and the sensed motion signal can be processed.

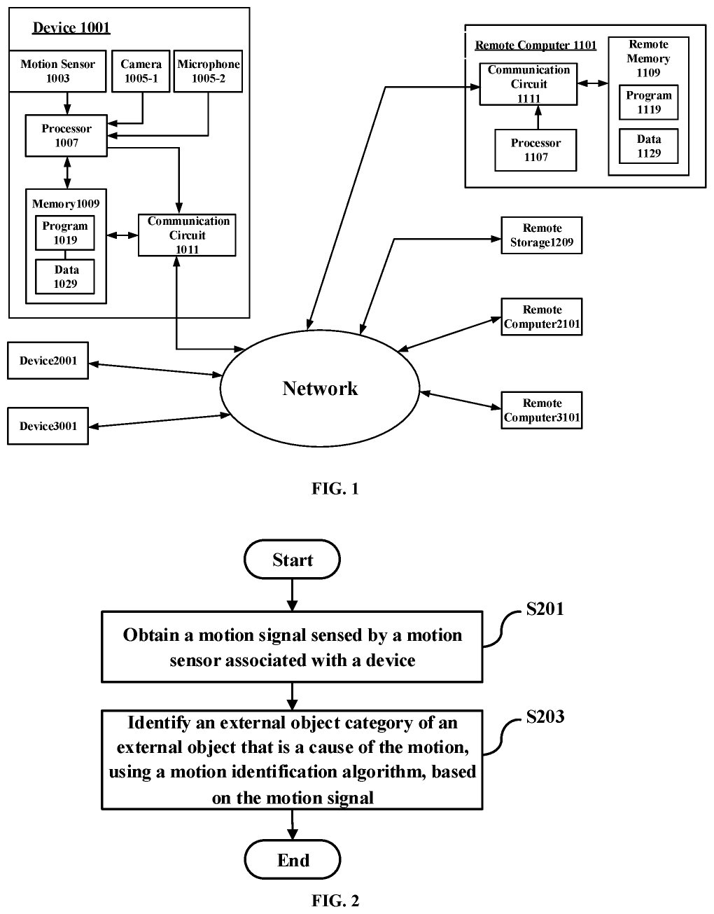

FIG. 1 is a schematic structural block diagram illustrating a system according to some exemplary embodiments of the present disclosure. The system shown in FIG. 1 may include a device 1001, which may be an aforementioned electrical device such as a base station device, a high-voltage power device, a control cabinet, a monitoring device, or a non-electrical device such as an entertainment facility, a mechanical instrument or meter, etc., which are located in an outdoor or complex work area. The device 1001 is not limited to these exemplified devices, as long as it may be subjected to motion under the influence of an external object. In the present disclosure, “motion” may be any mechanical motion and may include, but is not limited to, vibration, displacement, deformation, rotation, and so on.

The device 1001 may have an associated motion sensor 1003 configured to sense the motion of the device 1001 caused by an external object to obtain a motion signal. The motion sensor 1003 may include, for example, any one or more of the following: a displacement sensor, a velocity sensor, an acceleration sensor, a gyroscope, a vibration sensor, a force sensor, a strain sensor, an angular velocity sensor, an angular acceleration sensor, and the like. The motion sensor 1003 is not limited to any specific type of sensor, as long as the signal that it senses can reflect the motion of the device 1001. According to some embodiments, the motion sensor 1003 may be attached onto or inside the casing of the device 1001, or installed on any component of the device 1001. According to some embodiments, a plurality of motion sensors 1003 may be included, for example, the plurality of motion sensors 1003 may be installed or connected to different positions or different components of the device 1001, so that information such as rotation and deformation of the device 1001 may be sensed. Alternatively, the device 1001 may also have a camera 1005-1 and/or a microphone 1005-2, the camera 1005-1 is configured to capture images near the device 1001, and the microphone 1005-2 is configured to acquire sounds near the device 1001. A plurality of cameras 1005-1 (for example, installed in areas of the device 1001 facing different directions) may be included, so that images near the device 1001 can be captured more comprehensively. At least one of the images and sounds may be used as an additional signal other than the motion signal.

According to some embodiments, the device 1001 may include a processor 1007 and a memory 1009. The processor 1007 is configured to process a motion signal sensed by the motion sensor 1003, an image or video captured by the camera 1005-1, and/or a sound acquired by the microphone 1005-2. The memory 1009 is configured to store instructions or programs required by the processor 1009 for processing (such as an operating system and programs and applications according to the method of the present disclosure) and/or data (such as a motion signal, an additional signal, and/or other auxiliary data). The processor 1007 and the memory 1009 may be an additional processor and memory other than the processor and the memory used by the device 1001 to complete main work tasks, but may also be the processor and the memory used by the device 1001 to complete main work tasks. For example, in the case where the device 1001 is a base station controller, the processor 1007 and the memory 1009 may specifically execute the method according to the embodiment of the present disclosure, without processing base station control work, and may also be the processor and the memory used for base station control work. According to some embodiments, the device 1001 may further include a communication circuit 1011 configured to communicate with a remote device via a network.

According to some embodiments, the processor 1007, the memory 1009, and the communication circuit 1011 may be integrally formed as an electronic device (hereinafter also referred to as a “device associated with the device 1001”), and the electronic device may optionally have a casing, so that the electronic device can be integrally installed in the device 1001. The electronic device may further include the motion sensor 1003, the camera 1005-1, and/or the microphone 1005-2. The electronic device may have an independent battery, or may be powered by a power source of the device 1001 (for example, a battery, an industrial power source, or an AC power source). According to other embodiments, at least one of the motion sensor 1003, the camera 1005-1 and/or the microphone 1005-2, the processor 1007, the memory 1009, and the communication circuit 1011 may be installed or attached to the device 1001 separately from other components.

Although the device 1001 is shown in FIG. 1 as including the processor 1007 and the memory 1009, the device 1001 may also not include the processor 1007 and the memory 1009, but transmit the sensed and/or acquired signal (e.g., the motion signal and/or additional signal) through the communication circuit 1011 to other devices (such as a remote computer 1101), and the other devices calculate and process the signal.

According to some embodiments, the system shown in FIG. 1 may also include a remote computer 1101 that communicates with the device 1001 (or a device associated therewith) via a network. The remote computer 1101 can be configured to receive a signal (e.g., a motion signal, and/or an additional signal) from the device 1001 and process these signals. The remote computer 1101 may include a remote communication circuit 1111, a remote processor 1107, and a remote memory 1109. The remote memory 1109 is configured to store programs required by the processor 1107 for processing (such as an operating system and programs and applications according to the method of the present disclosure) and/or data (such as a motion signal, an additional signal, and/or other auxiliary data).

Alternatively, other devices (e.g., a device 2001, a device 3001 shown in FIG. 1) may communicate with a remote computer via a network. In addition, other remote computers (such as a remote computer 2101 and a remote computer 3101 shown in FIG. 1) can also be connected to the network and communicate with at least one of the devices 1001, 2001, 3001, or devices associated therewith. According to some embodiments, a remote storage 1209 may also be provided for remote access to programs or data by other devices or remote computers.

FIG. 2 is a flowchart illustrating a method for processing a motion signal according to an embodiment of the present disclosure. As shown in FIG. 2, the method may include: in step S201, obtaining a motion signal sensed by a motion sensor 1003 associated with a device 1001; and in step S203, identifying the external object category of an external object that is a cause of the motion, using a motion identification algorithm, based on the motion signal. The motion signal represents the motion of the device 1001 caused by the external object. The motion identification algorithm is based on a plurality of motion models respectively corresponding to a plurality of external object categories.

For example, the motion may include but not limited to, any one or more of the following: vibration, displacement, deformation, rotation, and so on. For example, the motion signal may include but not limited to, any one or more of the following: displacement (amplitude of motion), velocity, acceleration, angular velocity, angular acceleration, force, strain, etc. According to some embodiments, the motion signal may include only the amplitude of the motion signal. According to other embodiments, the motion signal may include a vector motion signal (for example, a three-dimensional vector motion signal), that is, not only the amplitude of the motion signal, but also the direction of the motion signal. According to some embodiments, the motion sensor is configured to perform signal sensing periodically (e.g., every second or every 0.5 seconds). Therefore, the motion signal may include a sequence of motion signals over time, for example, expressed as s (t)=(s (t1), s (t2), s (t3) . . . s (tn)), wherein s (t) represents a sequence of motion signals over time, t represents time, t1, t2, t3, . . . tn represent specific different time points, and s (t1), s (t2), s (t3) . . . s (tn) represents the amplitude or vector of the motion signal sensed at these different time points. The motion signal may also include a frequency-domain signal of the sensed signal, for example, a frequency-domain signal obtained via frequency-domain transformation such as Fourier transformation, wavelet transformation, and cosine transformation. The motion signal may also include a signal obtained by subjecting the sensed signal to any preprocessing (e.g., denoising, filtering, etc.).

The motion identification algorithm is configured to identify the external object category that is the cause of the motion, for example, it can identify whether a certain motion signal (e.g., a sequence of motion signals) is caused by an animal, by a human, by an aircraft taking off and landing, by the subway, or by the passing of a heavy truck, etc. The external object category is not limited thereto, and a motion identification algorithm capable of recognizing any external object category can be configured or trained as needed. The motion identification algorithm may be based on a plurality of motion models corresponding to a plurality of external object categories, respectively.

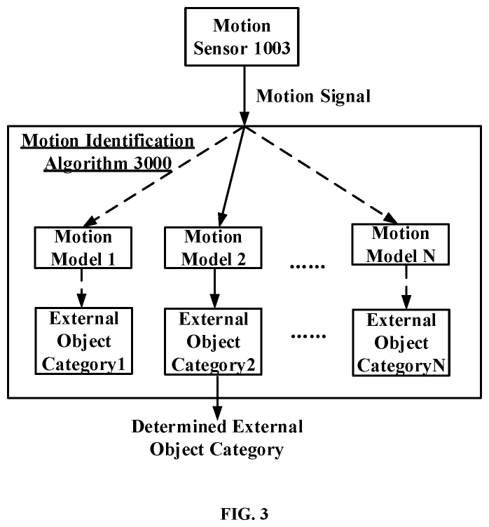

FIG. 3 is a schematic diagram illustrating a motion identification algorithm according to some exemplary embodiments of the present disclosure. As shown in FIG. 3, the motion identification algorithm 3000 obtains the motion signal sensed by the motion sensor 1003, and uses a plurality of motion models (motion model 1, motion model 2, . . . motion model N) to identify an external object of which one of external object category 1, external object category 2, . . . external object category N caused the motion signal. For example, if it is identified by using the motion model 2 that the motion signal is caused by an external object of the external object category 2, the external object category of the motion signal is determined to be the external object category 2.

The motion identification algorithm 3000 may adopt any pattern identification method, for example, may include but not limited to any one or more of the following: template matching method, K-nearest neighbor (K-NN) method, Bayesian classifier, principal component analysis method, linear discriminant analysis method, non-negative matrix factorization method, Gaussian mixture model, identification method using deep learning (such as neural network), etc. It should be understood that any pattern identification method can be used to construct the motion identification algorithm 3000. According to some embodiments, in order to identify the external object category that caused the motion, the motion signal may be pre-processed to extract the features of the motion signal. The features of the motion signal may include, but are not limited to, any one or more of the following: the average amplitude or power of the motion signal, the peak value of the amplitude or power of the motion signal, the duration of the motion signal amplitude or power exceeding a threshold, differential (trend) of the motion signal over time, integration of the motion signal over time, the directionality of the motion signal, variance of the motion signal, periodicity of the motion signal, frequency domain signals of motion signals, features within a specific time window, histogram information of motion signals based on any variables, linear transformation of a sequence of motion signals, nonlinear transformation of a sequence of motion signals, combinations of features of a plurality of kinds of motion signals, correlation calculation values of motion signals, and so on.

According to some embodiments, the motion identification algorithm 3000 is obtained by training in advance based on motion data of known external object categories. During the training process, based on the motion data of known external object categories, the features and parameters used by the motion identification algorithm 3000 for different external object categories can be continuously adjusted and updated, so as to obtain the trained motion identification algorithm 3000. In the case of deep learning (such as neural network) for motion identification, the features required for motion identification may not need to be manually determined in advance, but the features and parameters required for identification can be obtained directly during the training process based on existing data.

In the present disclosure, the corresponding “motion model” corresponding to a certain external object category includes at least one of a template, a mathematical model, and an algorithm (such as a classifier algorithm or an identifier algorithm), and related parameters thereof, for successfully determining the external object category. For example, in the case where the motion identification algorithm 3000 is a template matching method, a motion model corresponding to a specific external object category may include, for example, a motion template of the external object category and its parameters. As another example, in the case where the motion identification algorithm 3000 is a K-nearest neighbor (K-NN) method, a motion model corresponding to a specific external object category may include, for example, a feature vector structure for the external object category and existing specific feature vectors in the external object category. As another example, in the case where the motion identification algorithm 3000 is a Bayesian classifier, a motion model corresponding to a specific external object category may include, for example, a probability density function for the external object category and its related parameters. For another example, in the case where the motion identification algorithm 3000 is an identification method using a neural network, a motion model corresponding to a specific external object category may include, for example, the structure and related parameters of the neural network for the external object category. The motion model may be related to a specific device (for example, training for the motion signals of only one specific device), or may be applicable to a plurality of devices (for example, training for the motion signals of a plurality of devices). It should be understood that when programming the motion identification algorithm 3000, a plurality of motion models corresponding to different external object categories may not necessarily be embodied as separate program modules, but may be mixed or interleaved with each other. However, as long as the algorithm contains one or more segments of programs or instructions (which may include at least one of the aforementioned template, mathematical model, algorithm, and parameter) that can be used to identify specific external object categories, the segment(s) of programs or instructions can be considered to correspond to the motion model in the present disclosure.

The method shown in FIG. 2 (and method steps according to various exemplary embodiments described later) may be performed by the processor 1007 in the device 1001 (or a device associated therewith), or may be performed by another computing device located outside the device 1001 (e.g., the processor 1107 of the remote computer 1101). In the case where the method is performed by another computing device located outside the device 1001, the motion data sensed by the motion sensor 1003 associated with the device 1001 (alternatively, as well as an additional signal such as an image captured by the camera 1005-1 and/or a sound acquired by the microphone 1005-2) is transmitted to the another computing device, which performs the method according to the present disclosure.

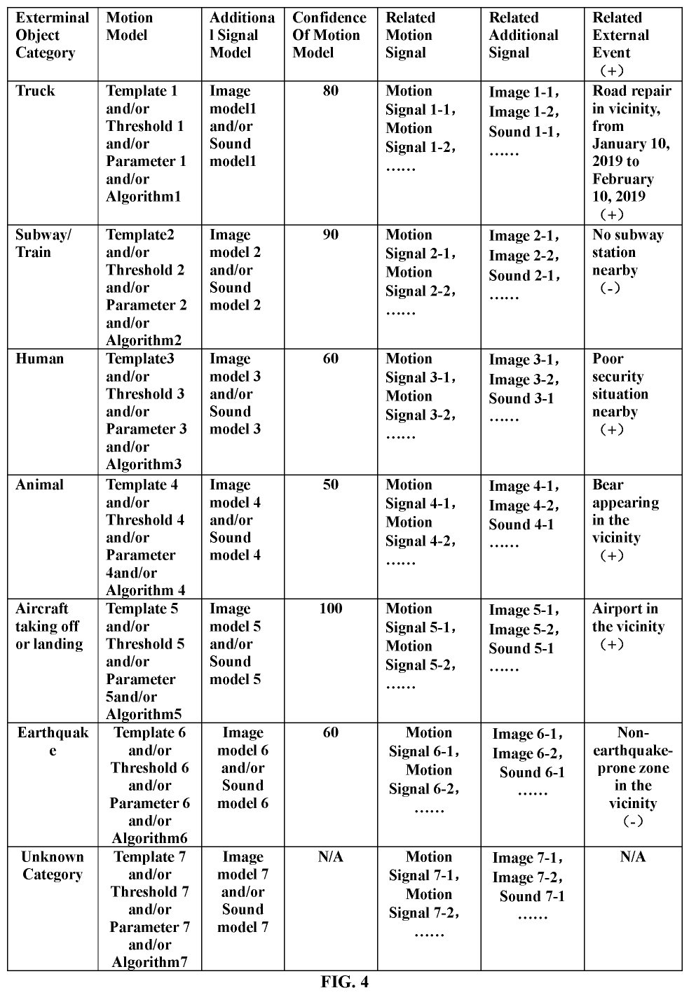

FIG. 4 is a diagram illustrating an example of data related to an external object category according to some exemplary embodiments of the present disclosure. The data shown in FIG. 4 may be stored in the memory 1009 included in the device 1001 or a device associated therewith (such as the electronic device described above), or may be stored in the memory of the remote computer. In the example shown in FIG. 4, the external object categories may include, for example, truck, subway/train, human, animal, aircraft takeoff and landing, earthquake, and unknown categories. As shown in FIG. 4, for each external object category, a motion model corresponding to the external object category (which may include corresponding template, threshold, parameters, or algorithm, etc.) may be stored associatively, and related motion signals obtained via a plurality of sensing may also be stored. The stored motion model may be trained based at least in part on these related motion signals.

According to some embodiments, alternatively, for each external object category, an additional signal model may also be stored. The additional signal model may include, for example, an image model and/or a sound model, the image model being configured to identify an external object of a corresponding external object category from an image, and the sound model being configured to identify an external object of a corresponding external object category from a sound. Similar to the motion model, the image model and/or sound model can respectively utilize any image identification algorithm and/or sound identification algorithm, and can utilize any image feature and/or sound feature, as long as an external object of the corresponding external object category can be identified from the image and/or sound. In this case, the data can also store related additional signals (e.g. images and/or sounds) in association with external object categories, for example.

According to some embodiments, alternatively, confidence may also be stored for each external object category. The confidence is the credibility degree of a motion model. The higher the confidence score is, the more credible the result of identifying the corresponding external object category via the motion model is. Although the figure only shows setting the confidence for the motion model, it is also possible to set the confidence for the additional signal model (e.g., image model and/or sound model).

According to some embodiments, alternatively, for each external object category, external events related to the location of the device 1001 may also be stored. Alternatively, the influence of related external events on the identification result can also be recorded. For example, in association with the external object category “truck”, a related external event may include that a road is being repaired near the location of the device 1001 during a certain period of time. Therefore, the possibility of a truck passing nearby increases, and it is recorded as a positive (“+”) influence on the identification of the external object category as a truck. If a specific external event indicates that the probability of occurrence of a specific external object category increases, the chance of identifying the external object category as the specific external object category may be increased (e.g., by weighting).

Although FIG. 4 shows a diagram of exemplary data examples related to external object categories, it should be understood that FIG. 4 is only a schematic diagram of data stored for performing the method of the present disclosure, and the storage form of the data is not limited thereto. In addition, the external object categories in FIG. 4 can also be further subdivided into a plurality of subcategories based on other factors such as motion category, motion duration, motion amplitude, or power. For example, a “human” category can be further divided into subcategories, such as “human kick”, “human knock”, “high-intensity continuous human destruction”, and the like.

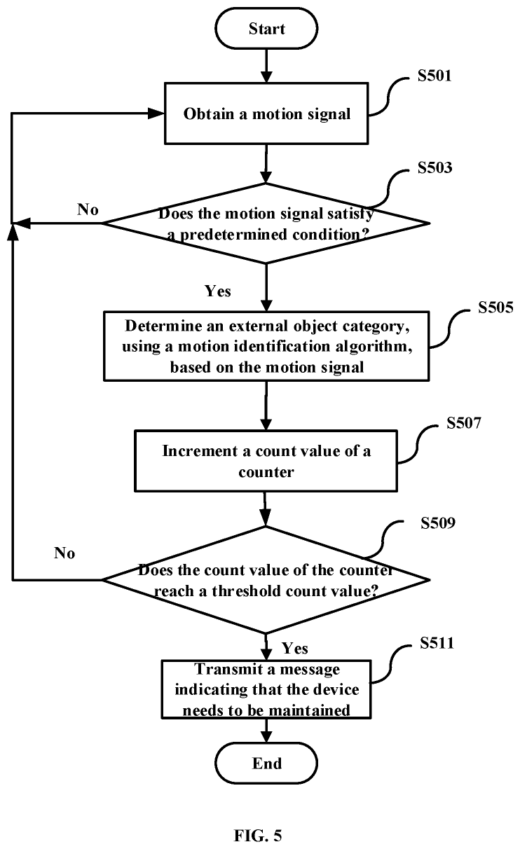

FIG. 5 is a flowchart illustrating a method for processing a motion signal according to some exemplary embodiments of the present disclosure. Motion detection is mainly used in the related art for a device that may produce significant mechanical motion during normal operation and a sensed motion is a motion produced by the device itself. Therefore, when an abnormal motion of the device is sensed according to the related art, the device often already has a failure. However, in many cases, the device itself does not produce high-intensity motion during operation, but only passively produces a motion under the influence of an external object. This passively produced motion does not necessarily directly cause a device failure, but it may gradually reduce the working performance of the devices when such motion occurs a plurality of times. It is hoped that when the accumulation of motion effects has reached a certain level but has not caused a device failure, the maintenance person can maintain the device in time. For this problem, a method for processing a motion signal as shown in FIG. 5 is provided.

According to the method shown in FIG. 5, in response to determining that a motion represented by a motion signal is caused by an external object of a specific external object category, a count value of a counter is incremented, and in response to the count value of the counter reaching a threshold count value, a message indicating that the device needs a maintenance is sent.

In particular, in step S501, a motion signal is obtained from the motion sensor 1003, for example. Then, in step S505, an external object category is determined, using a motion identification algorithm, based on the motion signal. Alternatively, prior to step S505, step S503 may be included to determine whether the motion signal satisfies a predetermined condition. According to some embodiments, the predetermined condition may include, for example, but not limited to, that the amplitude or power of the motion signal is greater than a threshold amplitude or threshold power. If it is determined in step S505 that the motion signal satisfies the predetermined condition, the flow advances to step S505, otherwise returns to step S501 to process the next motion signal. In other words, according to some embodiments, if the amplitude or power of the motion signal is too small, or if it is preliminarily determined that the motion signal will not adversely affect the performance of the device 1001, such motion signal may be ignored without further processing.

In step S507, in response to determining that the motion represented by the motion signal is caused by an external object of a specific external object category, the count value of the counter is incremented. In some cases, different external objects may affect different components of the device 1001 or cause different types of influence on the device 1001, respectively. Therefore, according to some embodiments, it is possible to set respective counters for different external object categories. In other cases, different external objects may cause the same component or the same type of accumulative effects on the device 1001. Therefore, according to some embodiments, it is also possible to set a common accumulation counter for a plurality of external object categories, so as to accumulate motion caused by these external object categories. It is also possible to set counters for individual external object categories as well as an accumulation counter for a plurality of external object categories.

The increment of the counter each time may be 1, or the increment of the count value of the counter can be weighted, depending on the specific external object category, the amplitude of the motion signal, the power of the motion signal, and/or the duration of the motion signal. The weight may be determined depending on the negative impact of the external object category, the amplitude of the motion signal, the power of the motion signal, and/or the duration of the motion signal on the device 1001. For example, the weight for truck passing can be set to 1, the weight for aircraft takeoff and landing can be set to 1.5, the weight for human knock can be set to 3, the weight for human kick can be set to 5, the weight for animal shaking can be set to 5, the motion signal lasting 1 second is further weighted by 1, the motion signal lasting 5 seconds is further weighted by 5, and so on, and a weight directly proportional to the motion signal amplitude or power can be further applied. Weighting the count value according to time is equivalent to accumulating time or weighting accumulation. Therefore, the accumulation of the time or weighting accumulation of the motion signal is also included in the scope of the present disclosure. According to some embodiments, if the external object category determined in step S505 is a category that does not adversely affect the performance of the device 1001, then in step S507, the count value of the counter may not be incremented (equivalent to a weight of 0). According to some embodiments, if the external object category determined in step S505 is a category and/or intensity that has a great negative impact on the performance of the device 1001, or requires special attention from the maintenance person or the police (such as high intensity continuous human destruction, or the presence of dangerous animals such as bears nearby), it is possible to directly notify the maintenance person and/or call the police. In other words, in response to determining that the motion represented by the motion signal is a specific motion caused by an external object of a specific external object category, a message indicating the specific external object category may be sent. Alternatively, an additional signal (such as an image, a sound, etc.) sensed by the additional signal sensor when the specific motion is sensed may be sent with the message, and/or the specific external object category identified by the motion identification algorithm is sent with the message, thereby making it easy for maintenance person or the police to determine the cause of the device motion.

In step S509, it can be determined whether the count value of the counter reaches a threshold count value. If the count value of the counter has reached the threshold count value, a message indicating that the device needs to be maintained may be sent (for example, it may be sent to the maintenance person or to a remote computer). Alternatively, an additional signal (such as an image, a sound, etc.) sensed by the additional signal sensor can be sent with the message, and/or the external object category identified by the motion identification algorithm every time can be sent with the message, thereby facilitating the maintenance person to determine the reason for the motion of the device. If the count value of the counter does not reach the threshold count value, it may return to step S501 to process the next motion signal. The threshold count value may be, for example, a count value at which the device 1001 is likely to have not failed but is about to fail, and may be determined in advance by means such as experience or computer simulation.

Although the exemplary method has been described with reference to FIG. 5, the method for counting motion signals is not limited thereto. For example, if it is expected that the external object category causing the motion of the device 1001 is single, the identification of the external object category may be omitted, and the count value may be weighted by using the amplitude of the motion signal, the power of the motion signal, and/or the duration of the motion signal, that is, step S505 can be omitted in FIG. 5. According to such an embodiment, in step S501, a motion signal sensed by a motion sensor 1003 associated with the device 1001 is obtained, and the motion signal representing the motion of the device 1001 caused by an external object. In step S503, it is determined whether the motion signal satisfies the aforementioned predetermined condition. The predetermined condition may include, for example, the amplitude of the motion signal being greater than a threshold amplitude, the power of the motion signal being greater than a threshold power, and/or the motion signal conforming to a specific pattern. In response to determining that the motion signal satisfies the predetermined condition S503, in step S507, the count value of the counter is increased. In step S509, it is determined whether the count value of the counter reaches the threshold count value. In step S509, in response to the count value of the counter reaching a threshold count value, a message indicating that the device needs to be maintained is sent. Similarly, depending on the amplitude of the motion signal, the power of the motion signal, and/or the duration of the motion signal, the increment of the count value of the counter can be weighted. Weighting the count value according to time is equivalent to accumulating time or weighting accumulation. Therefore, the accumulation of the time or weighting accumulation of the motion signal is also included in the scope of the present disclosure.

In some conventional technologies, for a low-intensity motion (such as a motion of the device caused by passing of a truck, aircraft takeoff and landing, human knock, etc.) of the device 1001 caused by an external object, if such low-intensity motion is insufficient to cause a device failure, then this low-intensity motion does not attract attention, but only an abnormal motion of the device that is sufficient to cause or indicate a device failure will attract attention. And if every such intense motion attracts attention every time, it will cause a waste of manpower and material resources. On the other hand, according to the exemplary method shown in FIG. 5, even for a low-intensity motion suffered by the device 1001 from an external object, since it can be counted, it is possible to monitor and consider the accumulative effect of such motion. Further, if such a count is weighted according to the external object category, the amplitude of the motion signal, the power of the motion signal, and/or the duration of the motion signal, the accumulative impact of these different motions can be more accurately determined. For example, the maintenance person may be notified to perform maintenance when the accumulation of motion effects has reached a certain level but has not yet caused a device failure, so as to avoid potential failures.

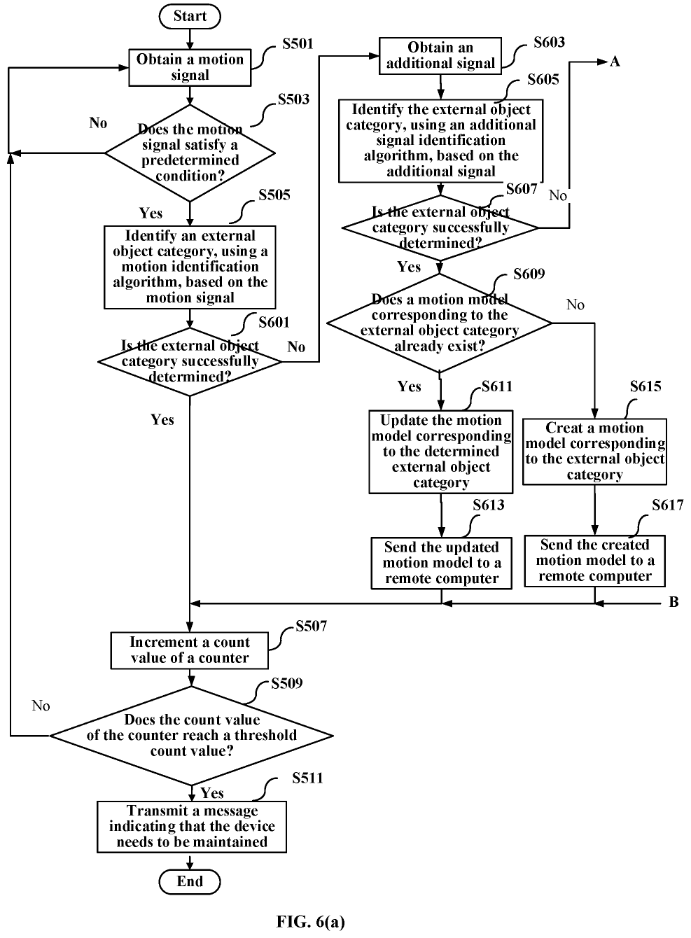

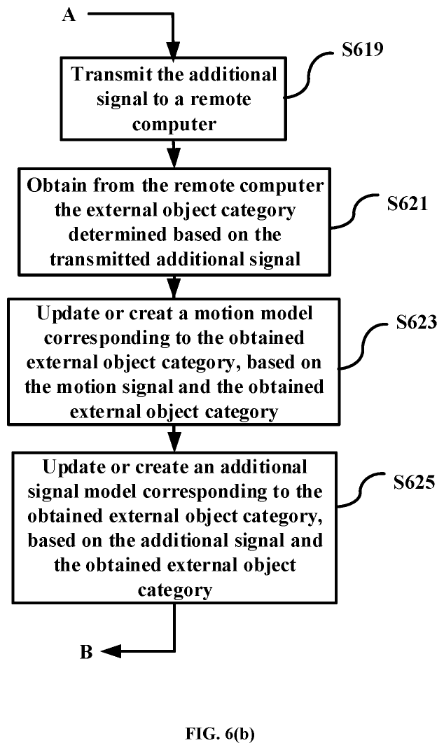

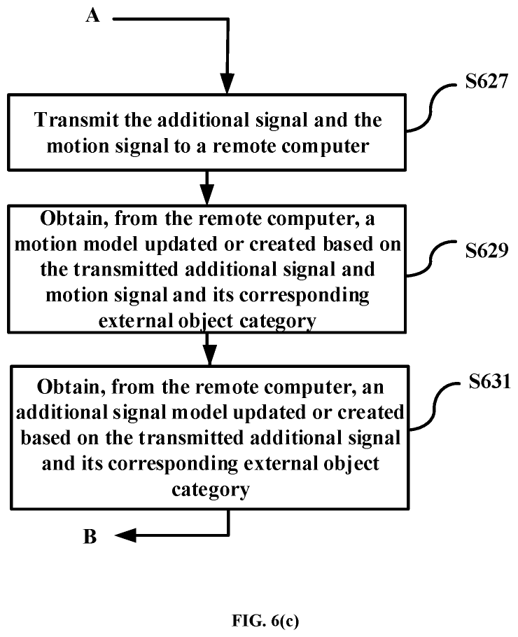

FIG. 6 (a), FIG. 6 (b), and FIG. 6 (c) are flowcharts illustrating a method for processing a motion signal according to some exemplary embodiments of the present disclosure. The methods of FIG. 6 (a), FIG. 6 (b), and FIG. 6 (c) may be performed by the device 1001 or its associated device (for example, the aforementioned electronic device). In the exemplary methods shown in these drawings, in addition to the use of a motion signal, an additional signal (such as but not limited to an image, a sound, etc.) is combined as auxiliary, to identify the external object category that is the cause of the motion.

According to the exemplary method shown in FIG. 6 (a), if the motion identification algorithm fails to determine the external object category that is the cause of the motion, an additional signal near the device obtained by the additional sensor is obtained. Then, based on the acquired additional signal, an additional signal identification algorithm is used to identify the external object category that is the cause of the motion. The additional signal identification algorithm is based on a plurality of additional signal models respectively corresponding to the plurality of external object categories.

In the exemplary method shown in FIG. 6 (a), steps S501-S505 may be the same as or similar to steps S501-S505 in FIG. 5, which will not be repeated here.

In step S601, it is determined whether the external object category is successfully determined in step S505. In some cases, it may not be possible to successfully determine the external object category, that is, the motion identification algorithm 3000 cannot determine which external object category an external object belongs to based on a motion signal. For example, when the actual external object category is subway, but there is no motion model in the memory corresponding to subway, but only motion models corresponding to truck, aircraft, and human, the motion signal may not match any of the motion models in the motion identification algorithms 3000. In other cases, when the actual external object category is subway, even there may be a motion model corresponding to the subway in the memory, but the amount of training data used when the motion model is trained is small, or the quality of training data used when the motion model is trained is not good, or the motion signal sensed this time is not typical for the motion caused by the subway, thus the motion signal caused by the subway may not match the motion model of the subway. In these cases, it may not be possible to successfully determine the external object category.

If it is determined in step S601 that the external object category is successfully determined, then as shown in FIG. 5, the count value of the counter may be incremented in step S507, and if it is determined in step S509 that the count value reaches the threshold count value, then in step S511, a message indicating that the device needs to be maintained is sent. Since steps S507-S511 here may be the same as or similar to steps S507-S511 in FIG. 5, they will not be repeated here.

If it is determined in step S601 that the external object category has not been successfully determined, the flow advances to step S603, wherein an additional signal near the device acquired by the additional sensor is obtained. The additional sensor may include, for example but not limited to, at least one of a camera and a microphone. The additional signal may include, for example but not limited to, at least one of an image and a sound, etc., as long as the additional signal can be used to identify an external object that appears nearby when the motion signal is sensed.

According to some embodiments, the additional sensor is configured to perform additional signal sensing periodically (e.g., every second or every 0.5 seconds). Therefore, the additional signal may include a sequence of additional signals over time, such as a sequence of images, a video signal, or continuous sound signals. As an alternative, a limited number of additional signals, such as one or several images or sounds within a predetermined period of time, may also be acquired only when a motion signal of which the amplitude or power is higher than a threshold amplitude or power is sensed. According to some embodiments, the additional signal may also include a frequency domain signal of the sensed signal, for example, a frequency domain signal obtained through frequency domain transformation such as Fourier transformation, wavelet transformation, and cosine transformation, etc. The additional signal may also include a signal obtained by subjecting the sensed signal to any pre-processing (e.g., filtering, etc.).

After obtaining the additional signal in step S603, in step S605, the external object category is identified, using an additional signal identification algorithm, based on the additional signal. The additional signal identification algorithm is configured to identify the external object category of the external object from the additional signal. For example, the image identification algorithm as the additional signal identification algorithm can identify whether the image as the additional signal contains an external object category such as animal, human, or truck. As another example, a sound identification algorithm as the additional signal identification algorithm can identify whether a certain segment of sounds as an additional signal contains sounds of external object categories such as human shouts, animal yelling, or truck driving sounds. The additional signal identification algorithm can use any pattern identification method. In particular, for images and/or sounds, any image identification algorithm and/or sound identification algorithm may be used.

The additional signal identification algorithm may be based on a plurality of additional signal models respectively corresponding to the plurality of external object categories. In the present disclosure, the corresponding “additional signal model” corresponding to a certain external object category includes at least one of a template, a mathematical model, and an algorithm (such as a classifier algorithm or an identifier algorithm), and its related parameters, for successfully determining the external object category. It should be understood that when programming the additional signal identification algorithm, a plurality of additional signal models corresponding to different external object categories are not necessarily embodied as separate program modules, but may be mixed or interleaved with each other. However, as long as the algorithm contains one or more segments of programs or instructions (which may include at least one of the aforementioned template, mathematical model, algorithm, and parameter) that can be used to identify specific external object categories, the segment(s) of programs or instructions can be considered to correspond to the motion model in the present disclosure.

Via the processing of steps S601-S605, in the case where the motion identification algorithm fails to identify the external object category, the additional signal (such as image or sound) associated with the external object can be used to make the additional signal identification become beneficial supplement to motion identification, thereby improving the success rate of identifying the external object category.

In step S607, it is determined whether or not the additional signal identification algorithm is successfully used to determine the external object category. If it is determined in step S607 that the external object category of the external object that is the cause of the motion is successfully determined using the additional signal identification algorithm, then the count value of the counter is incremented in step S507, and if it is determined in step S509 that the count value reaches the threshold count value, a message indicating that the device needs to be maintained is sent in step S511.

According to some embodiments, if it is determined in step S607 that the additional signal identification algorithm is used to successfully determine the external object category that is the cause of the motion, the method shown in FIG. 6 (a) may optionally further include step S609-S617, that is, to update or create a motion model corresponding to the determined external object category based on the motion signal and the external object category determined using the additional signal identification algorithm.

In step S609, it is determined whether a motion model corresponding to the determined external object category already exists. If it is determined in step S609 that a motion model corresponding to the determined external object category already exists (this indicates that the existing motion model may not be accurate or comprehensive enough), then in step S611 based on the motion signal and the determined external object category, the motion model corresponding to the determined external object category is updated. The updating here may include further training the existing motion model of the determined external object category using the motion signal. On the other hand, if it is determined in step S609 that there is no motion model corresponding to the determined external object category (this indicates that the external object category determined by the additional signal identification algorithm is an external object category unknown to the motion identification algorithm), then, in step S615, based on the motion signal and the determined external object category, a motion model corresponding to the determined external object category is created. The creation here may include creating a new motion model, and the newly created motion model is trained using the motion signal (optionally, more motion signals of the determined external object category may be combined).

According to steps S609-S617, in the case where the additional signal identification algorithm is used to successfully determine the external object category, the identification result of the additional signal identification algorithm can be used to improve the motion identification algorithm.

According to some embodiments, the plurality of motion models are obtained from a first remote computer. In this case, optionally, the updated or created motion model may also be sent to a second remote computer in step S613 or step S617. The first remote computer and the second remote computer may be the same computer or different computers. For example, the first remote computer and the second remote computer may both be computers on a private cloud. In other examples, the first remote computer may be a computer on a public cloud (such as the remote computer 1101 shown in FIG. 10), and the second remote computer may be a computer on a private cloud (such as the remote computer 3101 shown in FIG. 10). The first and second remote computers may enable other devices on the network to obtain updated or created motion models. As a result, other devices on the network can share new motion models that are updated or created with new information at any device.

According to some embodiments, if it is determined in step S607 that the additional signal identification algorithm still fails to determine the external object category that is the cause of the motion, the flow may proceed to step S619-S625 shown in FIG. 6 (b), or as an alternative, the flow may proceed to steps S627-S631 shown in FIG. 6 (c).

In the embodiment shown in FIG. 6 (b), in step S619, the additional signal is sent to a remote computer (such as the aforementioned first remote computer or second remote computer, which may be, for example, remote computer 1101 or 3101). According to some embodiments, the user of the remote computer may manually determine the associated external object category based on the additional signal. For example, the user can determine the associated external object by viewing an image or listening to a sound. In step S621, the external object category determined based on the transmitted additional signal is obtained from the remote computer. In step S623, based on the motion signal and the obtained external object category, a motion model corresponding to the obtained external object category is updated or created. For example, the motion signal can be used to further train an existing motion model of the determined external object category, or a new motion model can be created and the motion signal (alternatively, more motion signals of the determined external object category can be combined) can be used to train the newly created motion model.

According to steps S619-S623, even if the external object category cannot be successfully determined by using both the motion identification algorithm and the additional signal identification algorithm locally in the device 1001, the external object category can be identified by remote assistance, and the local motion identification algorithm can be improved by means of the external object category determined by remote assistance.

Optionally, the method shown in FIG. 6 (b) may further include step S625. In step S625, based on the additional signal and the obtained external object category, an additional signal model corresponding to the obtained external object category is updated or created. According to this step, the local additional signal identification algorithm can also be improved by means of the external object category determined by remote assistance.

As an alternative to the embodiment shown in FIG. 6 (b), in the embodiment shown in FIG. 6 (c), in step S627, both the additional signal and the motion signal are sent to a remote computer. According to some embodiments, the user of the remote computer may manually determine the associated external object category based on the additional signal, and the remote computer may update or create a motion model corresponding to the obtained external object category based on the motion signal and the determined external object category. The remote computer may store the motion model in synchronization with each device 1001 (or a device associated therewith). Therefore, the remote computer can use the motion signal to further train the existing motion model of the determined external object category, or create a new motion model and use the motion signal (alternatively, more motion signals of the determined external object category can be combined) to train the newly created motion model. In step S629, a motion model updated or created based on the transmitted additional signal and motion signal and its corresponding external object category are obtained from the remote computer.

According to steps S627-S629, even if the external object category cannot be successfully determined by using the motion identification algorithm and the additional signal identification algorithm locally in the device 1001, the external object category can be identified by means of remote assistance, and the remote computer can also assist in improving the local motion identification algorithm.

Optionally, the remote computer may update or create an additional signal model corresponding to the obtained external object category, based on the additional signal and the obtained external object category. In this case, the method shown in FIG. 6 (c) may further include step S631. In step S631, an additional signal model updated or created based on the transmitted additional signal and its corresponding external object category are obtained from the remote computer. According to this step, the local additional signal identification algorithm can also be improved by means of remote assistance.

After performing the steps in FIG. 6 (b) or FIG. 6 (c), the flow may return to step S507, and continue the processing in steps S507-S511.

Although some exemplary embodiments of the present disclosure have been described with reference to FIGS. 6 (a)-6 (c), it should be understood that the present disclosure is not limited by these exemplary embodiments, but some steps may be omitted or replaced. In addition, there may be some optional embodiments as follows.

According to some embodiments, the external object category that is the cause of the motion may be identified not only based on the motion signal and using the motion identification algorithm, but also based on information about an external event. The external event includes an event associated with an external object that caused a motion of the device, an example of which is shown in FIG. 4. Information about these external events may be obtained in advance from a remote computer, or it may be obtained in advance from other news sources (such as news websites or Really Simple Syndication (RSS)), or it may be manually inputted by the user. According to some embodiments, the information about an external event associated with a specific external object category may affect the motion identification algorithm 3000. In particular, if a specific external event indicates that the probability of occurrence of a specific external object category increases, then the chance of identifying an external object category as the specific external object category may be increased (e.g., by weighting). For example, when the motion identification algorithm 3000 uses a template matching method to identify an external image category, if an external message indicates that a road is being repaired nearby (thus a truck is more likely to pass by), the result obtained by performing correlation operations on the motion signal and the template corresponding to the specific external object category is weighted by a weight greater than 1.

According to some embodiments, confidence may be set for each motion model as shown in FIG. 4. In addition, although not shown in FIG. 4, confidence may also be set for each additional signal model. The confidence indicates the credibility degree of each model. The higher the confidence is, the more credible the identification result of the model is.

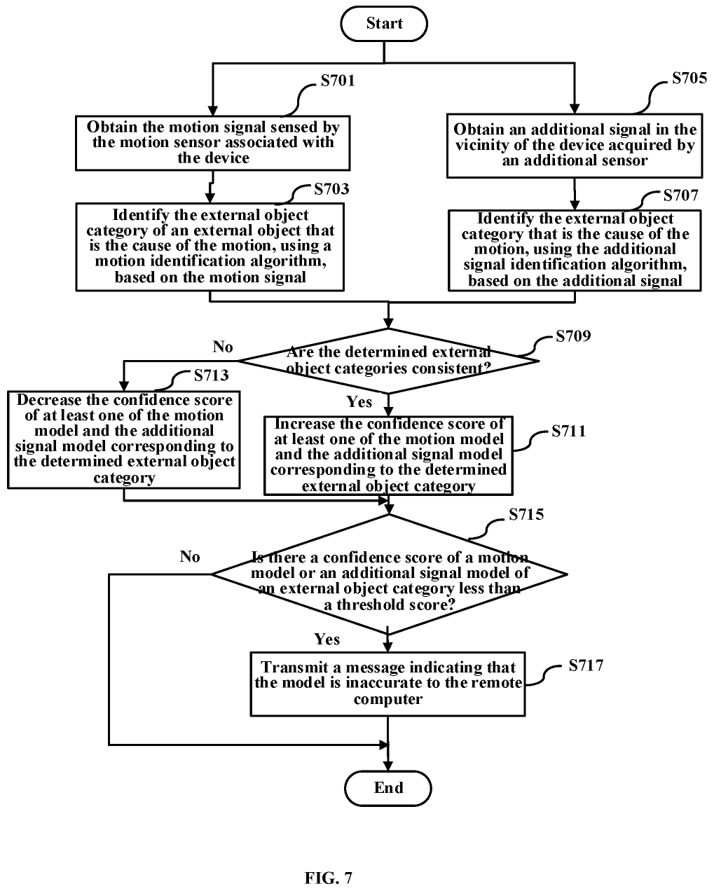

FIG. 7 is a flowchart illustrating a method related to a confidence score of a model according to some exemplary embodiments of the present disclosure.

In step S701, the motion signal sensed by the motion sensor 1003 associated with the device 1001 is obtained, and in step S703, the external object category of an external object that is the cause of the motion is identified using a motion identification algorithm, based on the motion signal. In addition, in step S705, an additional signal (e.g., an image or a sound) in the vicinity of the device acquired by an additional sensor (e.g., the camera 1005-1 and/or the microphone 1005-2) is obtained, and in step S707, the external object category that is the cause of the motion is identified using the additional signal identification algorithm, based on the additional signal. Steps S701-S703 and steps S705-S707 may have any order relationship, and they may be executed in parallel or sequentially.

In step S709, it is determined whether the external object category determined using the motion identification algorithm in step S703 and the external object category determined using the additional signal identification algorithm in step S707 are consistent. If the categories are consistent, then in step S711, the confidence score of at least one of the motion model and the additional signal model corresponding to the determined external object category is increased (e.g., increased by 1); and if the categories are not consistent, this indicates that the identification result of at least one of the motion model and the additional signal model is wrong, then in step S713, the confidence score of at least one of the motion model and the additional signal model corresponding to the determined external object category is decreased (for example, decreased by 1). According to some embodiments, in the initial state, the confidence score of each model may be set to any initial score (for example, 70), and then on this basis, the confidence score is increased or decreased according to the result of performing steps S701-S709 each time when the external object category is identified.

In step S715, it can be determined whether the confidence score of the motion model or the additional signal model corresponding to one external object category is less than the threshold score. If it is determined in step S715 that the confidence score of the motion model or additional signal model corresponding to the one external object category is less than the threshold score, then a message indicating that the motion model or the additional signal model corresponding to the one external object category is inaccurate may be sent to the remote computer in step S717. The threshold score may be set according to a specific application or experience, and for example, may be set to a value (for example, 50 or 60) lower than an initial score. According to some embodiments, after receiving a message that the model of a specific external object category is inaccurate, the remote computer may use more data to train the model and use the retrained model for the device. According to other embodiments, the user of the remote computer may manually examine model defects or possible problems, and use the model whose problem is resolved for the device.

According to some embodiments, when a plurality of devices share a motion model or an additional signal model via a remote computer, the remote computer may maintain a uniform confidence score. For example, each device or its associated electronic device may send a request to increase or decrease the confidence score of a certain model to the remote computer, and the remote computer uniformly increases or decreases the confidence score. The remote computer can also set a uniform confidence storage area, which can be accessed by different devices or their associated electronic devices to increase or decrease the confidence score of each model. In this case, the remote computer can monitor the confidence score of each model uniformly, and solve the problem of the model if the confidence score of a certain model is less than the threshold score.

According to some embodiments, in the case where there are a plurality of additional signal identification algorithms (e.g., an image identification algorithm, a sound identification algorithm), in step S605 of FIG. 6 (a), the additional signal identification algorithm with a higher average confidence score of an additional signal model may be preferentially used.

In some cases, there may be a plurality of external objects causing a motion of the device 1001 at the same time. For example, it may be that the device 1001 undergoes human knock while a truck passes by. Therefore, a plurality of external object categories that cause a motion of the device 1001 can be identified.

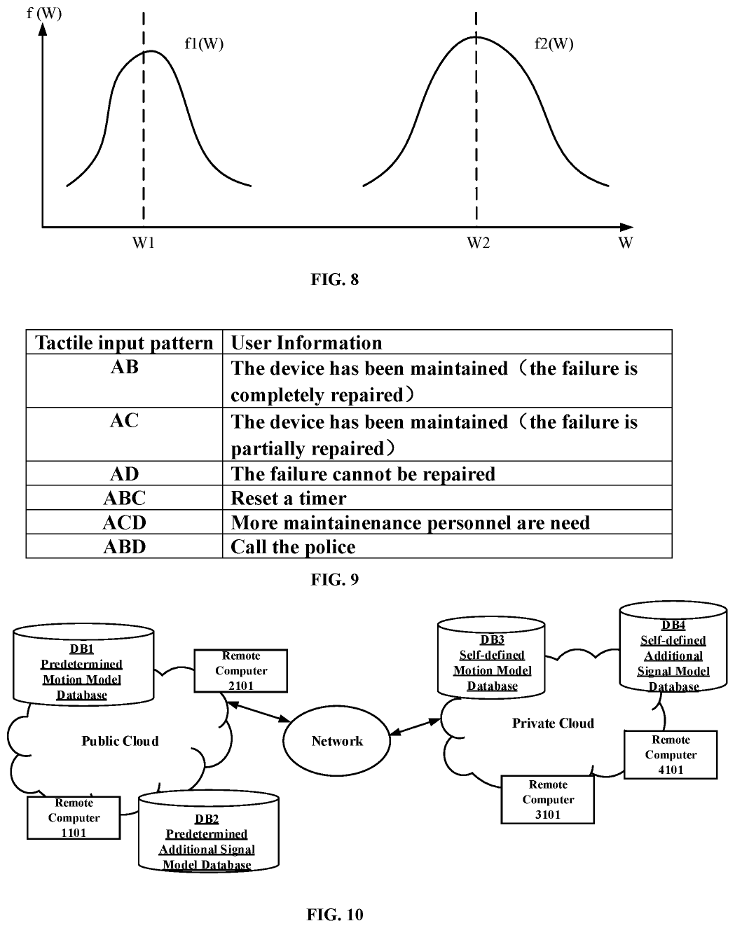

According to some embodiments, it may be determined whether the motion is caused by the superimposition of motion objects of a plurality of external object categories, based on the frequency domain signal of the motion signal. The frequency domain signal may be a signal obtained by performing frequency domain transformation (for example, Fourier transformation, cosine transformation, wavelet transformation) on the motion signal. Since motion signals caused by some different external objects may occupy different frequency domain regions, they can be distinguished in the frequency domain. FIG. 8 is a schematic diagram illustrating an example of frequency domain signals of motion signals of different external objects according to some exemplary embodiments of the present disclosure. As shown in FIG. 8, the frequency domain signal f(W) of a motion signal may include a signal f1(W) with a center frequency W1 (which is typically the center frequency of a motion signal caused by an external object category), and a signal f2(W) with a center frequency W2 (which is typically the center frequency of a motion signal caused by another external object category). Therefore, the frequency domain signal f(W) of the motion signal can be separated into a signal f1(W) and a signal f2(W), and motion identification can be performed on the motion signals corresponding to the signal f1(W) and the signal f2(W) respectively. In other words, if it is determined that the motion is caused by the superposition of motion objects of a plurality of external object categories, then the frequency domain signal can be separated into a plurality of signals for the plurality of external object categories, respectively, and based on each of the plurality of signals, the corresponding external object category is separately identified.

According to other embodiments, especially in the case where the number of external object categories is small, in addition to a motion model representing a device motion caused by a motion object of a single external object category (for example, a motion model for trucks), the motion identification algorithm 3000 may also optionally include a motion model representing a device motion caused by the superimposition of motion objects of a plurality of external object categories (e.g., a motion model of the superimposition of a motion caused by a truck passing and a motion caused by an human knock).

According to the above-described exemplary embodiment, not only the motion caused by a single external object but also the motion caused by a plurality of external objects together can be identified.

According to some embodiments, the device 1001 or a device associated therewith (for example, the electronic device described above) may be further provided with an input device for input by a user (for example, a maintenance person). Devices for user input may include, but are not limited to, a button, a mouse, a keyboard, a touch screen, a touch pad, a controller lever, and so on. According to some embodiments, the maintenance person may personally go to the site of the device 1001 to view, record, and/or maintain the device 1001 when receiving, for example, the aforementioned message indicating that the device needs maintenance. After processing the device, the maintenance person may input one or more of various information to the device 1001 or the device associated therewith (such as the electronic device described above) via the input device. For example, the maintenance person can input information indicating that the device has been maintained (the failure is completely repaired), the device has been maintained (the failure is partially repaired), or the failure has not been repaired according to the maintenance situation of the machine. After successfully maintaining the device, the maintenance person can input information to reset the counter. When the maintenance person finds that there are special circumstances that require special treatment, for example, they can input information to indicate that the maintenance persons need to be added or to call the police. At this time, the communication circuit of the device 1001 can send information requiring the addition of the maintenance person or calling the police to the related communication destination.

According to some embodiments, the above input device may be implemented by means of buttons or tactile input components (e.g., a pressure sensor). A combination of several buttons and/or a combination of tactile input components can express a variety of different user information. FIG. 9 is a diagram illustrating an example of a predetermined correspondence relationship between tactile input patterns and user information according to some exemplary embodiments of the present disclosure. A plurality of buttons or tactile input components may correspond to A, B, C, and D, respectively, and via different combinations of tactile input patterns, a variety of different user information can be implemented with a simple structure. Therefore, the device 1001 or a device associated therewith (such as the electronic device described above) can receive a user's tactile input to a button or a tactile input component, and according to the correspondence relationship between different patterns of the tactile input and different information, convert the user's tactile input into corresponding information.

According to the above-described exemplary embodiment, since user information and/or communication information related to maintenance can be input via the input device of the device 1001 or the device associated therewith, it is possible to eliminate the need for the user to use their own mobile device or the like to record or send information. In particular, if a simple input device such as a button or a tactile input component is used, it may be particularly advantageous for a device in a low-temperature environment, as the lithium battery of a conventional mobile device may have poor operating performance in a low-temperature environment.

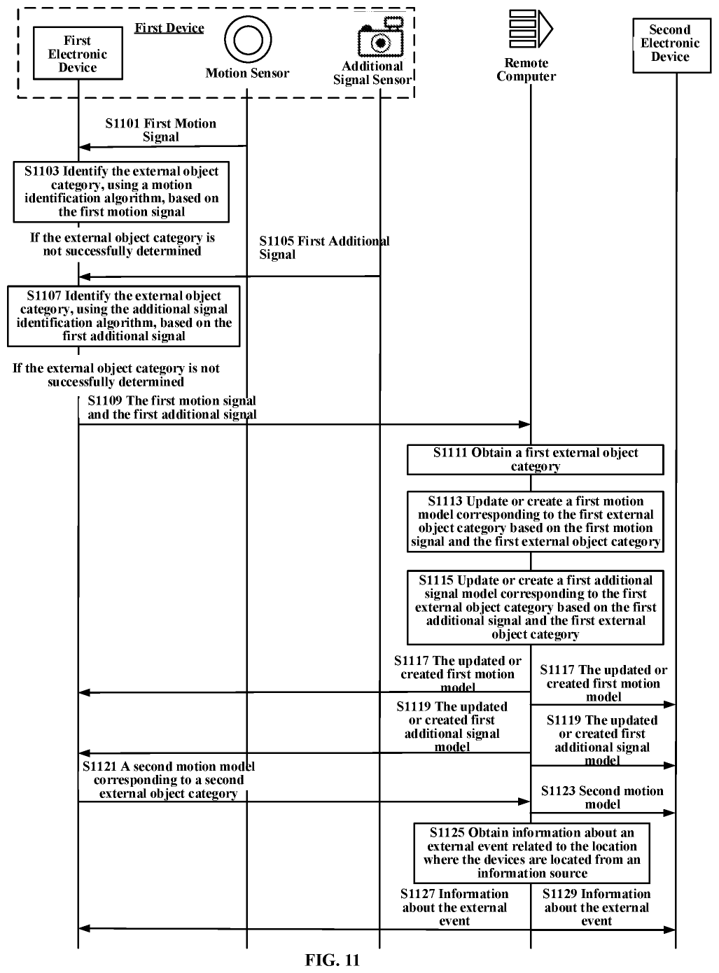

The method and apparatus for processing a motion signal according to various exemplary embodiments of the present disclosure have been described above from the perspective of the device 1001. Hereinafter, an exemplary embodiment of a remote computer and a database will be described in conjunction with the schematic diagram of FIG. 10 and the flowchart of FIG. 11.

FIG. 10 is a schematic diagram illustrating a remote computer and a database according to some exemplary embodiments of the present disclosure. The private cloud shown in FIG. 10 may be controlled by an entity that owns the device 1001 or is responsible for maintaining the device 1001 and other similar devices (for example, a communication company that owns the base station controller or is responsible for maintaining the base station controller). The remote computer 3101 and/or 4101 can maintain a self-defined motion model database DB3 on a private cloud, and optionally, can also maintain a self-defined additional signal model database DB4 on a private cloud. The self-defined motion model database DB3 can store motion models of a plurality of external object categories, and the self-defined additional signal model database DB4 can store additional signal models of a plurality of external object categories. Therefore, the device 1001 or a device associated therewith (such as the aforementioned electronic device) can obtain the aforementioned model (motion model and/or additional signal model) from the remote computers 3101 and/or 4101 located on the private cloud, and use these models to identify external object categories. The data shown in FIG. 4 can also be maintained in the self-defined motion model database DB3 and the self-defined additional signal model database DB4. In the case where the data shown in FIG. 4 is stored in a self-defined database on a private cloud, related external events may include a plurality of related external events associated with different locations where various devices are deployed, and the confidence is a centralized confidence score of feedbacks from a plurality of devices.

In steps S613 and S617, and after step S623 and after step S625, the device 1001 or a device associated therewith (such as the aforementioned electronic device) may send the updated or created motion model and/or additional signal model to the remote computers 3101 and/or 4101 on the private cloud, the remote computers 3101 and/or 4101 can use the received models to update the models in the self-defined motion model database DB3 and the self-defined additional signal model database DB4. In addition, after step S627, the remote computers 3101 and/or 4101 may use the received motion signals and additional signals to update or create a motion model and/or additional signal model, and use the updated or created motion model and/or additional signal model to update the self-defined motion model database DB3 and the self-defined additional signal model database DB4. After updating the models in the databases DB3 and DB4 based on the signal associated with the device 1001, other similar devices can also use the updated models, so that a plurality of similar devices connected to the private cloud can benefit from updated information of any of the devices.

The public cloud shown in FIG. 10 can be controlled by a cloud service provider. The remote computers 1101 and/or 2101 may maintain a predetermined motion model database DB1 on a public cloud, and optionally, may also maintain a predetermined additional signal model database DB2 on a public cloud. The remote computers 3101 and/or 4101 on the private cloud can submit the motion model and/or additional signal model in their self-defined motion model database DB3 and self-defined additional signal model database DB4 to the public cloud. If the remote computers 1101 and/or 2101 on the public cloud can confirm the safety and reliability of the received motion model and/or additional signal model, the received models can be used to update models in the predetermined motion model database DB1 and the predetermined additional signal model database DB2.

Since the public cloud not only provides services to specific device owners or maintainers, different device owners or maintainers (such as different communication companies) can obtain models from the remote computers 1101 and/or 2101 located in the public cloud and use these models to identify external object categories. Therefore, different device owners or maintainers communicatively connected to the public cloud can benefit from the updated information of any one of the devices.

According to some embodiments, the device 1001 or a device associated therewith (such as the aforementioned electronic device) may obtain a motion model and/or an additional signal model from a remote computer (the first remote computer) on the public cloud, and transmit the updated or created model to a remote computer (the second remote computer) on the private cloud. The device 1001 or a device associated therewith (for example, the aforementioned electronic device) may also obtain a motion model and/or an additional signal model from a remote computer (the second remote computer) on the private cloud. The device 1001 or a device associated therewith (such as the aforementioned electronic device) can obtain a model from a remote computer in one of the following ways: actively requesting the model from the remote computer, reading the model from the corresponding database via the remote computer, or receiving the model that the remote computer actively sends or pushes.

FIG. 11 is a flowchart illustrating a method for processing a motion signal by an electronic device and a remote computer according to some exemplary embodiments of the present disclosure. In particular, FIG. 11 shows the interaction operation between a first electronic device, a remote computer (e.g., the remote computer 3101 on a private cloud), and a second electronic device. The first electronic device may be the first device (for example, the device 1001) itself, or may be a device associated with the first device (for example, the electronic device described above). The second electronic device may be the second device (for example, the device 2001) itself, or may be a device associated with the second device (for example, the electronic device described above). The first electronic device and the second electronic device can communicate with the remote computer. The method flow of FIG. 11 can be applied to the aforementioned scenarios shown in FIGS. 1 and 10, and can also be applied to the methods shown in FIGS. 2, 5, 6 (a)-6 (c) and 7.

As shown in FIG. 11, the first electronic device obtains a first motion signal from the motion sensor 1003 (step S1101), and identifies the external object category using a motion identification algorithm, based on the first motion signal (step S1103). If the external object category is not successfully determined, the first electronic device obtains a first additional signal from the additional signal sensor (step S1105), and identifies the external object category using the additional signal identification algorithm, based on the first additional signal (step S1107). If the external object category is still not successfully determined, the first electronic device transmits the first motion signal and the first additional signal to the remote computer (step S1109).

The remote computer obtains the first motion signal and the first additional signal from the first electronic device (step S1109), the first motion signal is a motion signal sensed by a motion sensor associated with the first device, and the first additional signal is an additional signal near the first device acquired by the additional sensor. After receiving the first additional signal, the user of the remote computer can manually identify the external object category of the external object in the first additional signal (i.e., the first external object category), and input the manually identified external object category into the remote computer. Alternatively, the remote computer may identify the external object category (i.e., the first external object category) from the first additional signal via an additional signal identification algorithm executed in itself or by another computer. Thus, the remote computer can obtain a first external object category, which is the external object category of the first external object shown in the first additional signal (step S1111).

The remote computer may update or create a first motion model corresponding to the first external object category based on the first motion signal and the first external object category (step S1113). In particular, if a first motion model corresponding to the first external object category already exists in the database of the remote computer, the first motion model corresponding to the first external object category is updated based on the first motion signal and the first external object category. If there is no first motion model corresponding to the first external object category, a first motion model corresponding to the first external object category is created based on the first motion signal and the first external object category. For example, the first motion signal may be used to further train an existing motion model of the determined external object category, or a new motion model is created and the first motion signal is used optionally, more motion signals of the determined external object category may be combined) to train the newly created motion model. Then, the first electronic device and a second electronic device different from the first electronic device can be enabled to obtain the first motion model (step S1117).

Optionally, the remote computer may also update or create a first additional signal model corresponding to the first external object category based on the first additional signal and the first external object category (step S1115). In particular, if a first additional signal model corresponding to the first external object category already exists in the database of the remote computer, the first additional signal model corresponding to the first external object category is updated based on the first additional signal and the first external object category. If there is no first additional signal model corresponding to the first external object category, a first additional signal model corresponding to the first external object category is created based on the first additional signal and the first external object category. Then, the first electronic device and the second electronic device can be enabled to obtain the first additional signal model (step S1119).

Via the steps above, the remote computer can use manual or more powerful identification algorithms to determine the external object category, and use motion signals for which the external object category is not successfully identified to update or create a motion model. Optionally, not only the motion model can be updated or created, but also an additional signal model can be updated or created using an additional signal for which the external object category is not identified at the device locally. After updating or creating these models at the remote computer, a plurality of devices communicating with the remote computer can all obtain the updated or created models, so as to achieve information sharing of external object categories.

According to some embodiments, the remote computer may also obtain a second motion model corresponding to a second external object category from the first electronic device (step S1121), and enable the second electronic device to obtain the second motion model (step S1123). The second motion model may be a model updated or created at the first electronic device. Thus, the second electronic device can share the model updated or created by the first electronic device via a remote computer (for example, a remote computer on a private cloud).

According to some embodiments, the remote computer may also obtain information about an external event related to the location where the first device and the second device are located from an information source, where the external event is associated with the external object that caused the motion of the first device or the second device (step S1125). Thereafter, the remote computer may enable the first electronic device to obtain information about the external event related to the location of the first electronic device (step S1127), and enable the second electronic device to obtain information about the external event related to the location of the second electronic device (step S1129). Thus, the remote computer can collect external events associated with external objects that cause device motion, and share such external events to electronic devices in the corresponding location, thereby facilitating the electronic devices in using the external events to assist the identification of external object categories.

According to some embodiments, the method performed by the remote computer shown in FIG. 11 may be implemented in a remote computer included in a private cloud. In this case, the method may further include: the remote computer submitting the updated or created first motion model to the public cloud, and/or submitting the second motion model received from the first electronic device to the public cloud. If the public cloud can confirm the security and reliability of the model received from the private cloud, the received model can be used to update the model in the database of the public cloud.

Although the method for processing a motion signal of the present disclosure has been described in conjunction with the example in which a device that may be at outdoor is moved by the influence of external objects such as people, trucks, and the like, the applicable situation of the method is not limited thereto. The device 1001 may also be a first component in the device, and the external object may also be a second component that is outside the first component but inside the device. For example, some electronic device is equipped with a fan and a speaker, both of which may cause motions (such as vibrations) of other components within the electronic device. Although these motions may be slight, they can cause, when accumulated, hard drive failure, loose screws, or other problems. Therefore, the motion of some components of the electronic device caused by the fan and the speaker, etc., is sensed and the corresponding motion signal is processed (for example, identifying or counting the motion signal), so as to issue a warning when the counter reaches the threshold count value, to facilitate the maintenance person in performing maintenance.

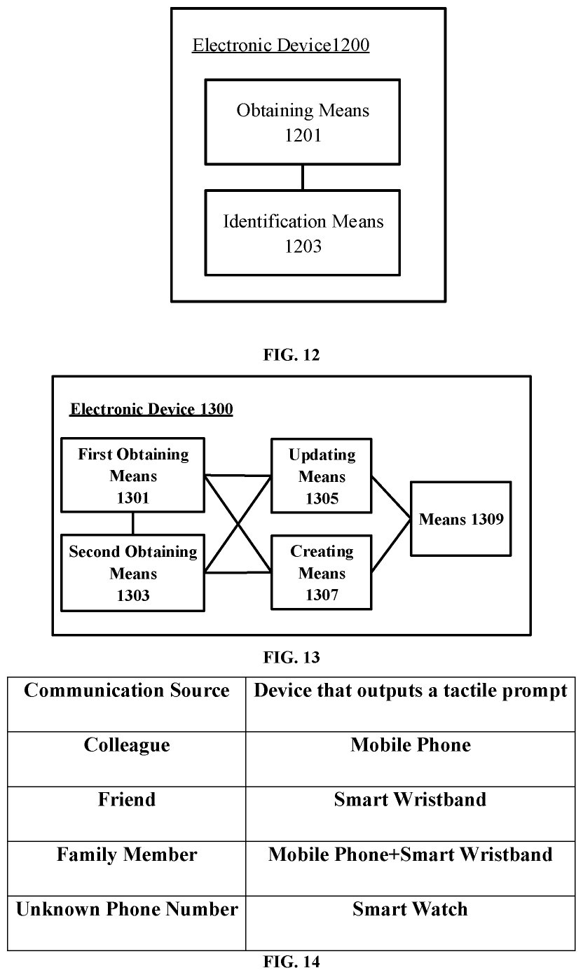

Various embodiments of the method for processing a motion signal at the device side and the remote computer side has been described above in conjunction with FIGS. 1 to 11. The electronic device according to some exemplary embodiments of the present disclosure is briefly described below with reference to FIG. 12 and FIG. 13. The FIG. 12 and FIG. 13 are structural block diagrams illustrating an electronic device according to some exemplary embodiments of the present disclosure.

As shown in FIG. 12, the electronic device 1200 may be a device for processing a motion signal, which may include an obtaining means 1201 configured to obtain a motion signal sensed by a motion sensor associated with the device, the motion signal represents the motion of the device caused by an external object. The electronic device 1200 may further include an identification means 1203 configured to identify an external object category of an external object that is the cause of the motion using a motion identification algorithm based on the motion signal, wherein the motion identification algorithm is based on a plurality of motion models respectively corresponding to a plurality of external object categories. The electronic device 1200 may be the aforementioned device 1001, or may be an integrated electronic device (i.e., a device associated with the device 1001) that can be installed on the device 1001, or may be a remote device (for example, a remote computer or server, etc.) located at a remote location of the device 1001.

As shown in FIG. 13, the electronic device 1300 may be a device for processing a motion signal, which may include a first obtaining means 1301 configured to obtain a first motion signal and a first additional signal from a first electronic device, the first motion signal is a motion signal sensed by a motion sensor associated with the first device, and the first additional signal is an additional signal near the first device acquired by an additional sensor. The electronic device 1300 may further include a second obtaining means 1303 configured to obtain a first external object category, the first external object category being the external object category of the first external object shown in the first additional signal. The electronic device 1300 may further include an updating means 1305 and a creating means 1307. The updating means 1305 is configured to, if there is a first motion model corresponding to the first external object category, update the first motion model corresponding to the first external object category based on the first motion signal and the first external object category. The creating means 1307 is configured to, if there is no first motion model corresponding to the first external object category, create (S1113) a first motion model corresponding to the first external object category based on the first motion signal and the first external object category. In addition, the electronic device 1300 may further include a means 1309 configured to enable the first electronic device and a second electronic device different from the first electronic device to obtain the first motion model. The electronic device 1300 may be the aforementioned remote computer, for example, at least one of the remote computers 1101, 2101, 3101, and 4101.

Although the electronic device 1200 and the electronic device 1300 given above include various means respectively configured to perform some of the steps shown in FIGS. 2 and 11, it should be understood that the electronic device 1200 and the electronic device 1300 may also include means configured to perform other steps in other flowcharts or other steps in the foregoing description. In other words, as long as a step is mentioned in the present disclosure, a means configured to perform the step may be included in the corresponding electronic device 1200 and electronic device 1300.

According to some embodiments, the electronic device 1200 may be implemented to include a processor and a memory. The processor may be, for example, the aforementioned processor 1007 or 1107, and the memory may be, for example, the aforementioned memory 1009, 1109, or 1209. The memory may be configured to store a computer program including computer readable instructions, which when executed by the processor, cause the processor to execute any method steps performed by the aforementioned device 1001 or the device associated therewith. For example, the computer readable instructions may cause the processor to execute the method steps described in conjunction with FIGS. 2, 5, 6 (a)-6 (c), 7-10 or method steps performed by the first electronic device in FIG. 11.

Optionally, the electronic device 1200 may further include a motion sensor (e.g., the motion sensor 1003) configured to sense motion signals. Optionally, the electronic device 1200 may further include an additional signal sensor, such as a camera configured to capture an image near the device 1001 as an additional signal (for example, the camera 1005-1), and/or a microphone configured to acquire a sound near the device (1001) as an additional signal (for example, the microphone 1005-2).

According to some embodiments, the electronic device 1300 may be implemented to include a processor and a memory. The processor may be, for example, the aforementioned processor 1107, and the memory may be, for example, the aforementioned remote memory 1109. The memory may be configured to store a computer program that includes computer readable instructions that when executed by the processor cause the processor to execute any method steps performed by the aforementioned remote computer (for example, at least one of the remote computers 1101, 2101, 3101, and 4101). For example, the computer readable instructions may cause the processor to perform the method steps performed by the remote computer 3101 in FIG. 11.

The present disclosure also provides a computer readable storage medium that stores a computer program, the computer program including computer readable instructions, which when executed by the processor, can cause the memory to execute any method steps as described above.

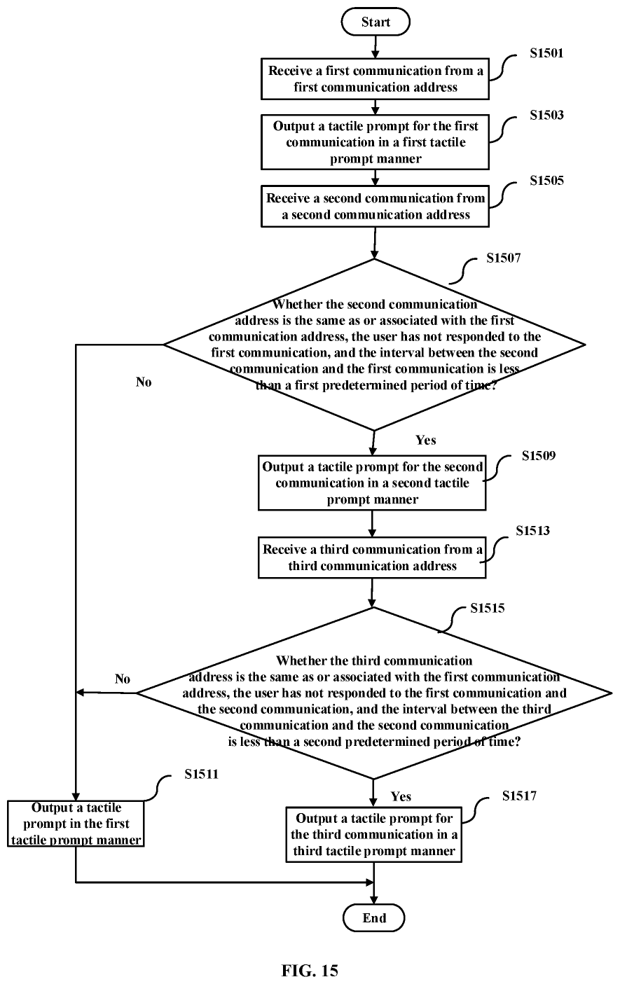

Some exemplary embodiments using tactile prompts will be described below in conjunction with FIGS. 14-15.

In recent years, a plurality of mobile devices (optionally, a plurality of wearable devices may be included) held by users may form an Internet of Things through communication means such as Bluetooth. According to some embodiments of the present disclosure, a plurality of mobile devices in the Internet of Things can be selectively used to output tactile prompts, so that a user can obtain a variety of information without visually viewing a mobile device or relying on the mobile device's audible prompts.

The method for providing a tactile prompt for the received communication may include the following steps, for example. A communication is received by a mobile phone. In response to the occurrence of a first communication event, a first device is caused to output a tactile prompt. In response to the occurrence of a second communication event, a second device different from the first device is caused to output a tactile prompt. Wherein, at least one of the first device and the second device is different from the mobile phone. According to some embodiments, in response to the occurrence of a third communication event, the first device and the second device may also be caused to output tactile prompts at the same time.

According to some embodiments, the first communication event, the second communication event, and the third communication event may have different communication types. For example, the first communication event includes receiving a phone call, the second communication event includes receiving a short message, and the third communication event includes receiving an instant messaging message. According to some embodiments, the first communication event, the second communication event, and the third communication event may for example have different communication sources. For example, the first communication event includes communication from a first communication source, and the second communication event includes communication from a second communication source.

Each of the first device and the second device may be one of the following: the mobile phone, a first smart wearable device (such as a smart wristband), and a second smart wearable device (such as a smart watch). Each of the first device and the second device includes tactile feedback components, such as a vibrator, a pressure generator, and so on. The first device and the second device may for example communicate via Bluetooth, a wireless local area network, or other short-range wireless communication methods. For example, the mobile phone may make a determination on a communication event upon receiving the communication event, and selectively instruct the mobile phone or other mobile device (for example, a smart wearable device) to output a tactile prompt.

FIG. 14 is a diagram illustrating an example of a correspondence relationship between a communication source and a device that outputs a tactile prompt according to some exemplary embodiments of the present disclosure. As shown in FIG. 14, when the mobile phone receives communications from different communication sources (such as a colleague, a friend, a family member), different mobile devices (such as a mobile phone, a smart wristband, a smart watch, or any combination thereof) are caused to output tactile prompts. It is also possible to configure a specific mobile device to output a tactile prompt for a specific mobile number.

The present disclosure may provide an electronic device including a processor, and a memory configured to store a computer program, the computer program including computer readable instructions that when executed by the processor, cause the processor to execute the method for selectively instructing different devices or a combination thereof to output tactile prompts according to different communication events as described above.

With the above method and device, the user does not need to view the mobile device visually or rely on the audible prompt of the mobile device, and can determine what kind of communication event has occurred according to from which device the tactile prompt is felt. For example, according to the example of FIG. 14, if the vibration of the smart wristband is felt, it may be known that a friend is calling, and if the vibration of the mobile phone is felt, it may be known that a colleague is calling. This may be particularly helpful in situations where it is inconvenient to frequently view the mobile device visually, or when the sound is noisy and it is difficult to perceive audible prompts (such as in social situations or in bad weather).

FIG. 15 is a flowchart illustrating a method for providing a tactile prompt for a received communication according to some other exemplary embodiments of the present disclosure. According to the embodiment shown in FIG. 15, if repeated communications from the same or associated communication address (for example, from the same phone number or from the same person) are received within a short period of time, the user is prompted by a special tactile prompt manner, so that the user can distinguish a communication that may need to be answered or replied from the numerous communications.

In step S1501, a first communication from a first communication address is received. In step S1503, in response to receiving the first communication from the first communication address, a tactile prompt for the first communication is output in a first tactile prompt manner. In step S1505, after receiving the first communication, a second communication from a second communication address is received. Each of the first communication address and the second communication address may be, for example, one of a specific phone number, a specific email address, and a specific instant messaging account. Each of the first communication and the second communication may be, for example, one of a telephone call, a short message, an email, and an instant messaging message, and the first communication and the second communication may have the same or different communication types.

In step S1507, it is determined whether the second communication address is the same as or associated with the first communication address, whether the user has not responded to the first communication, and whether the interval between the second communication and the first communication is less than a first predetermined period of time. “Same” means the completely same address. For example, if the first communication address is, for example, a specific mobile phone number, the second communication address is also the specific mobile phone number. “Associated” means being originated from the same communication source, for example, if the first communication address is, for example, a person's mobile phone number, the associated second communication address may be the account of the same person's instant messaging message or the email address of the same person. The first predetermined event period may be set according to application requirements, for example, it may be set to any period of time from 5 minutes to 20 minutes. In other words, in step S1507, it is determined whether two short-interval communications from the same person (in same or different communication manners) have been received in step S1501 and in step S1505. If the second communication address is the same as or associated with the first communication address, the user does not respond to the first communication, and the interval between the second communication and the first communication is less than the first predetermined period of time, then in step S1509, a tactile prompt for the second communication is output in a second tactile prompt manner different from the first tactile prompt manner. Otherwise, in step S1511, the tactile prompt for the second communication is still output in the first tactile prompt manner. The first tactile prompt manner and the second tactile prompt manner may be different in at least one of the following aspects: tactile feedback manner (such as vibration and pressure), vibration frequency, vibration intensity, and vibration pattern (such as two short with one long or three long with one short etc.). For example, the second tactile prompt manner may have a higher vibration frequency, a higher vibration intensity, and/or a more uneven vibration pattern, etc. than the first tactile prompt manner.

According to the above steps, if the communication source has urgent matters and therefore frequently communicates, the user can be prompted by a special tactile prompt. The user can thus know which communications are urgent and important without frequently looking at the mobile phone in order to answer or reply in time.

Similarly, in step S1513, after receiving the second communication, a third communication from a third communication address may be received further. In step S1515, it is determined whether the third communication address is the same as or associated with the first communication address, whether the user has not responded to the first communication and the second communication, and whether the interval between the third communication and the second communication is less than a second predetermined period of time. If the third communication address is the same as or associated with the first communication address, the user does not respond to the first communication and the second communication, and the interval between the third communication and the second communication is less than the second predetermined period of time, then in step S1517, a tactile prompt for the third communication is output in a third tactile prompt manner. Otherwise, in step S1511, the tactile prompt for the third communication is still output in the first tactile prompt manner. The second predetermined period of time may for example be equal to, greater than, or less than the first predetermined period of time. The third tactile prompt can be different from the first tactile prompt and the second tactile prompt, that is, they can be different in at least one of the following ways: a tactile feedback manner (e.g. vibration and pressure), vibration frequency, vibration intensity, vibration pattern (for example, two short with one long or three long with one short, etc.). For example, the third tactile prompt manner may have a higher vibration frequency, a higher vibration intensity, and/or a more uneven vibration pattern, etc. than the first and second tactile prompt manners.

The present disclosure may provide an electronic device including a processor and a memory configured to store a computer program, the computer program including computer readable instructions that when executed by the processor, cause the processor to execute the method for outputting a tactile prompt in a specific tactile prompt manner when the same communication source repeatedly performs communication within a short time as described above.

Via the above method and device, the user can know the repeated communications from the same or associated communication address (for example, from the same phone number or from the same person) within a short period of time according to a specific tactile prompt manner. Therefore, for example, when it is inconvenient to frequently check the mobile device in a visual manner or when the environment is noisy and it is difficult to perceive the audible prompt (such as in a social occasion or bad weather occasion), the user can still accurately, efficiently and properly handle, such as answer or reply, potentially important or urgent communications.

Combining the foregoing various embodiments, the following exemplary application scenarios can be imagined. It should be noted that this scenario is only an exemplary scenario for understanding the application and technical effects of the technical solution of the present disclosure, and is not intended to limit the scope of the present disclosure. A base station controller (for example as an example of the device 1001) is placed in a faraway and snowy town. The motion of the base station controller is identified and counted at an electronic device associated with the base station controller using the algorithms shown in FIG. 2, FIG. 5, FIG. 6 (a)-FIG. 6 (c), FIG. 7 and/or FIG. 11, and a counter at the base station controller used to count motion reaches the threshold. In this case, the electronic device associated with the base station controller sends a message indicating that the base station controller needs to be maintained. Along with the message, the electronic device associated with the base station controller also sends images around the device captured during the procedure of the counter reaching the threshold, and historical identification results of external object categories by a motion sensor. After receiving the message, the maintenance person initially confirms that the motion of the device was caused by the frequent passing of snowplows and the shaking by animals. Therefore, the maintenance person decides to go to the town to maintain the base station controller.

After reaching the site of the base station controller, the maintenance person finds that the motion of the device caused by external objects did cause the loosening of the screws of important components, but the abnormal work of the device had not yet been caused, so the maintenance person repairs the device. This repair makes timely prevention, before the device malfunctions and causes actual losses. After repair, according to the correspondence relationship between tactile input patterns and user information shown in FIG. 9, the maintenance person presses a tactile input component (such as a pressure sensor) to input an AB signal to indicate that the machine has been maintained (the failure is completely repaired), and input an ABC signal to issue a reset command to the counter. As the image and motion identification results both indicate that there may be a big animal in the vicinity enough to affect the device, the maintenance person also inputs an ABD signal to call the police, prompting the police to strengthen safety protection of people and property around.

On the way to the base station controller and back to the office, the maintenance person may receive a phone call via a mobile phone. Although it is inconvenient for the maintenance person to frequently take out his mobile phone to check it because of the cold weather, he can still determine the source of the communication based on which mobile device the tactile prompt comes from, so as to decide whether to answer the call. In addition, if a specific tactile prompt is received to indicate that the same phone number frequently calls, he can determine that there is an urgent matter and choose to answer the call.

After returning to the office, the maintenance person can send the event that the town has been snowing and there is a large animal appearing in the town to a remote computer on a private cloud, as an external event related to the location of the town. The maintenance person can also set and send the impact of such external events on the identification result of the external object category of the local device, for example, to increase the chance of determining the external object category as “animal” and “truck”. The remote computer on the private cloud can enable other similar devices of the same base station controller supplier in the town to share these external events, so that other similar devices can also consider the impact of nearby external events in identifying external object categories. The remote computer on the private cloud can also submit these external events to a public cloud. If a remote computer on the public cloud confirms that the received external event is from a reliable source, it may store the aforementioned external event associated with the location of the town on the public cloud. Thus, even different device suppliers can share these external events, so that the impact of nearby external events can be taken into consideration in identifying external object categories.

Via various embodiments of the present disclosure, tactile sensing and tactile feedback can be fully utilized, thereby improving work efficiency in various aspects and enhancing user experience.

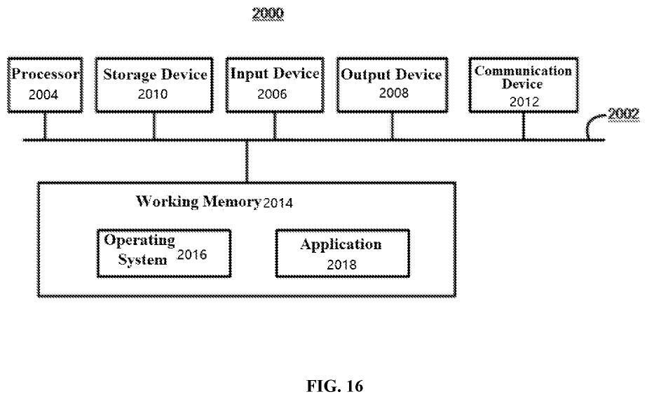

Referring to FIG. 16, a computing device 2000 will now be described, which is an example of a hardware device that can be applied to various aspects of the present disclosure. The computing device 2000 may be any machine configured to perform processing and/or calculations, and may be, but not limited to, a workstation, a server, a desktop computer, a laptop computer, a tablet computer, a personal digital assistant, a smart phone, a vehicle-mounted computer, or any of combinations thereof. The aforementioned device 1001, the device associated with the device 1001, various electronic devices, various remote computers, the mobile phone, the mobile device, the wearable device, etc. may be wholly or at least partially implemented by the computing device 2000 or a similar device or system.

The computing device 2000 may include elements (possibly via one or more interfaces) connected to a bus 2002 or in communication with the bus 2002. For example, the computing device 2000 may selectively include the bus 2002, one or more processors 2004, one or more input devices 2006, and one or more output devices 2008. The one or more processors 2004 may be any type of processor, and may include, but are not limited to, one or more general-purpose processors and/or one or more special-purpose processors (e.g., special processing chips). The processor 2004 may be used to implement the aforementioned processor 1007, the processor 1107, the electronic device 1200, the electronic device 1300, or any other processor and/or controller described above. The input device 2006 may be any type of device capable of inputting information to the computing device 2000, and may include, but is not limited to, a mouse, a keyboard, a touch screen, a microphone, a camera, a remote control, buttons, tactile input components (e.g., a pressure sensor), and so on. The output device 2008 may be any type of device capable of presenting information, and may include, but is not limited to, a display, a speaker, a video/audio output terminal, a vibrator, and/or a printer. The computing device 2000 may also include or be connected to a non-transitory storage device 2010. The non-transitory storage device may be any non-transitory storage device that can implement data storage, and may include but is not limited to a disk drive, an optical storage device, a solid-state memory, a floppy disk, a flexible disk, a hard disk, a magnetic tape or any other magnetic medium, an optical disk or any other optical medium, a read only memory (ROM), a random access memory (RAM), a cache and/or any other memory chip or cartridge, and/or any other medium from which the computer can read data, instructions, and/or code. The non-transitory storage device 2010 can be detached from the interface. The non-transitory storage device 2010 may have data/programs (including instructions)/code for implementing the methods and steps above. The storage device 2010 may be used to implement the aforementioned memory 1009, the remote memory 1109, the remote memory 1209, and any other memory described above, and may be used to store any programs or data in FIG. 3, FIG. 4, FIG. 9, and FIG. 14, and can also be used to store computer programs and/or computer readable instructions for performing any of the method steps shown in FIGS. 2, 5, 6 (a)-6 (c), 7, 11, and 15. The computing device 2000 may also include a communication device 2012. The communication device 2012 may be any type of device or system that enables communication with external devices and/or with a network, and may include, but is not limited to, a modem, a network card, an infrared communication device, a wireless communication device and/or a chipset, such as a Bluetooth™ device, a 1302.11 device, a Wi-Fi device, a WiMAX device, a cellular communication device, and/or the like. The communication circuit 1011, the communication circuit 1111, and any other communication circuit described above can for example be implemented by the communication device 2012.

The computing device 2000 can also include a working memory 2014, which can be any type of working memory that can store programs (including instructions) and/or data useful for the work of the processor 2004, and can include, but is not limited to, a random access memory and/or read-only memory device. The working memory 2014 may be used to implement the aforementioned memory 1009, the remote memory 1109, the remote memory 1209, and any other memory described above, and may be used to store any programs or data in FIG. 3, FIG. 4, FIG. 9, and FIG. 14, and may also be used to store computer programs and/or computer readable instructions for performing any of the method steps shown in FIGS. 2, 5, 6 (a)-6 (c), 7, 11, and 15.

Software elements (programs) may be located in the working memory 2014, including but not limited to an operating system 2016, one or more applications 2018, drivers and/or other data and codes. Instructions for performing the above methods and steps may be included in one or more applications 2018, and the aforementioned obtaining means 1201 and identifying means 1203 of the electronic device 1200, and the aforementioned first obtaining means 1301, the second obtaining means 1303, the updating means 1305, the creating means 1307, and the means 1309 of the electronic device 1300 can each be implemented by the processor 2004 reading and executing instructions of one or more applications 2018. More specifically, the aforementioned obtaining means 1201 may be implemented by, for example, the processor 2004 executing the application 2018 having the instructions to execute step S201, and the aforementioned identifying means 1203 may be implemented, for example, by the processor 2004 executing the application 2018 having the instructions to execute step S203. In addition, the aforementioned first obtaining means 1301 may be implemented by, for example, the processor 2004 executing the application 2018 having the instructions to execute step S1109, and the aforementioned second obtaining means 1303 may be implemented, for example, by the processor 2004 executing the application 2018 having the instructions to execute step S1111, and the aforementioned updating means 1305 can be implemented, for example, by the processor 2004 executing the application 2018 having the instructions to execute step S1113, and the aforementioned creating means 1307 can be implemented, for example, by the processor 2004 executing the application 2018 having the instructions to execute step S1113, the aforementioned means 1309 can be implemented, for example, by the processor 2004 executing the application 2018 having the instructions to execute step S1117. The other means of the electronic devices 1200 and 1300 described above may also be implemented, for example, by the processor 2004 executing the application 2018 having the instructions to execute one or more of the steps described in the present disclosure. The executable code or source code of the instructions of the software elements (programs) may be stored in a non-transitory computer readable storage medium (such as the above-mentioned storage device 2010), and may be stored, when executed, in the work memory 2014 (that may be compiled and/or installed). The executable code or source code of the instructions of the software element (program) can also be downloaded from a remote location.

It should also be understood that various modifications can be made according to specific requirements. For example, custom hardware may also be used, and/or specific elements may be implemented in hardware, software, firmware, middleware, microcode, hardware description languages, or any combination thereof. For example, some or all of the means and components in the disclosed methods and device may be implemented by using logics and algorithms according to the present disclosure and using assembly language or a hardware programming language (such as VERILOG, VHDL, C++) to program hardware (e.g., a programmable logic circuit including field programmable gate array (FPGA) and/or programmable logic array (PLA)).

It should also be understood that the foregoing method may be implemented via a server-client mode. For example, a client may receive data inputted by a user and send the data to a server. The client can also receive the data inputted by the user, perform part of the processings in the foregoing method, and send the resulting data to the server. The server may receive the data from the client, and execute the aforementioned method or another part of the aforementioned method, and return the execution result to the client. The client can receive the execution result of the method from the server, and can present it to the user via an output device, for example.

It should also be understood that the components of the computing device 2000 may be distributed on the network. For example, one processor may be used to perform some processing, while at the same time other processing may be performed by another processor remote from that processor. Other components of the computing system 2000 may be similarly distributed. In this way, the computing device 2000 can be interpreted as a distributed computing system that performs processing at a plurality of locations.

Although the embodiments or examples of the present disclosure have been described with reference to the drawings, it should be understood that the above method, system, and device are merely exemplary embodiments or examples. The scope of the invention is not limited by these embodiments or examples, but it is only limited by the claims after authorization and their equivalent scope. Various elements in the embodiments or examples may be omitted or may be replaced by equivalent elements thereof. In addition, the steps may be performed in an order different from that described in the present disclosure. Further, various elements in the embodiments or examples may be combined in various ways. It is important that as the technology evolves, many of the elements described here can be replaced by equivalent elements that appear after the present disclosure.

1-43. (canceled)

44. A method for processing a motion signal, the method comprising:
obtaining a motion signal sensed by a motion sensor associated with a device, the motion signal representing a motion of the device caused by an external object; and
identifying an external object category of the external object that is a cause of the motion, using a motion identification algorithm, based on the motion signal, wherein the motion identification algorithm is based on a plurality of motion models corresponding to a plurality of external object categories, respectively.

45. The method of claim 44, further comprising:
incrementing a count value of a counter, in response to determining that the motion represented by the motion signal is caused by the external object of a specific external object category; and
transmitting a message indicating that the device needs to be maintained, in response to the count value of the counter reaching a threshold count value.

46. The method of claim 45, further comprising:
weighting an increment of the count value of the counter, depending on the specific external object category, an amplitude of the motion signal, an power of the motion signal, and/or a duration of the motion signal.

47. The method of claim 44, further comprising:
if the external object category of the external object that is the cause of the motion is not successfully determined using the motion identification algorithm, then
obtaining an additional signal near the device acquired by an additional sensor, and
identifying the external object category of the external object that is the cause of the motion, using an additional signal identification algorithm, based on the additional signal, wherein the additional signal identification algorithm is based on a plurality of additional signal models corresponding to the plurality of external object categories respectively.

48. The method of claim 47, further comprising:
if the external object category of the external object that is the cause of the motion is successfully determined using the additional signal identification algorithm, then
updating a motion model corresponding to the determined external object category based on the motion signal and the determined external object category, if there is already the motion model corresponding to the determined external object category;
creating a motion model corresponding to the determined external object category based on the motion signal and the determined external object category, if there is no motion model corresponding to the determined external object category.

49. The method of claim 48,
wherein the plurality of motion models is obtained from a first remote computer; and
wherein the method further comprises transmitting the updated or created motion model to a second remote computer.

50. The method of claim 47, further comprising:
if the external object category of the external object that is the cause of the motion is not successfully determined using both the motion identification algorithm and the additional signal identification algorithm, then
transmitting the additional signal to a remote computer;
obtaining from the remote computer the external object category determined based on the transmitted additional signal; and
updating or creating a motion model corresponding to the obtained external object category, based on the motion signal and the obtained external object category.

51. The method of claim 50, further comprising:
updating or creating an additional signal model corresponding to the obtained external object category, based on the additional signal and the obtained external object category.

52. The method of claim 47, further comprising:
if the external object category of the external object that is the cause of the motion is not successfully determined using both the motion identification algorithm and the additional signal identification algorithm, then
transmitting the additional signal and the motion signal to a remote computer; and
obtaining from the remote computer an motion model updated or created based on the transmitted additional signal and the motion signal, and its corresponding external object category.

53. The method of claim 52, further comprising:
obtaining from the remote computer an additional signal model updated or created based on the transmitted additional signal, and its corresponding external object category.

54. The method of claim 44, wherein identifying the external object category of the external object that is the cause of the motion comprises:
identifying the external object category of the external object that is the cause of the motion, based on the motion signal, by using the motion identification algorithm, and based on information about an external event, wherein the external event is associated with the external object that caused the motion of the device.

55. The method of claim 44, further comprising:
obtaining an additional signal near the device acquired by an additional sensor;
identifying the external object category of the external object that is the cause of the motion, using an additional signal identification algorithm, based on the additional signal, wherein the additional signal identification algorithm is based on a plurality of additional signal models corresponding to the plurality of external object categories respectively;
increasing a confidence score of at least one of the motion model and additional signal model corresponding to the determined external object category, if the external object category determined using the motion identification algorithm is consistent with the external object category determined using the additional signal identification algorithm;
decreasing the confidence score of at least one of the motion model corresponding to the external object category determined using the motion identification algorithm and the additional signal model corresponding to the external object category determined using the additional signal identification algorithm, if the external object category determined using the motion identification algorithm is inconsistent with the external object category determined using the additional signal identification algorithm.

56. The method of claim 55, further comprising:
transmitting to a remote computer a message indicating that the motion model or additional signal model corresponding to one external object category is inaccurate, in response to the confidence score of the motion model or additional signal model corresponding to the one external object category being less than a threshold score.

57. The method of claim 44, wherein identifying the external object category that is the cause of the motion comprises:
determining whether the motion is caused by a superimposition of motion objects of a plurality of external object categories based on a frequency domain signal of the motion signal;
separating the frequency domain signal into a plurality of signals respectively for the plurality of external object categories, if the motion is caused by the superposition of motion objects of the plurality of external object categories; and
identifying the corresponding external object category respectively, based on each of the plurality of signals;
wherein the plurality of motion models comprise at least one of:
a motion model representing the motion of the device caused by a motion object of a single external object category; or
a motion model representing the motion of the device caused by a superposition of motion objects of a plurality of external object categories; and
wherein the method further comprises at least one of:
transmitting a message indicating a specific external object category, in response to determining that the motion represented by the motion signal is a specific motion caused by an external object of the specific external object category; or
receiving a tactile input of a user to a pressure sensor and converting the tactile input of the user to corresponding information, according to a correspondence relationship between different patterns of the tactile input and different information.

58. The method according to claim 47, wherein the additional signal comprises at least one of an image and a sound.

59. A method for processing a motion signal, the method comprising:
obtaining a motion signal sensed by a motion sensor associated with a device, the motion signal representing a motion of the device caused by an external object;
incrementing a count value of a counter, in response to determining that the motion signal satisfies a predetermined condition; and
transmitting a message indicating that the device needs to be maintained, in response to the count value of the counter reaching a threshold count value.

60. The method of claim 59, wherein the predetermined condition comprises:
an amplitude of the motion signal being greater than a threshold amplitude, a power of the motion signal being greater than a threshold power, and/or the motion signal conforming to a specific pattern; and
wherein the method further comprises:
weighting an increment of the count value of the counter, depending on an amplitude of the motion signal, a power of the motion signal, and/or a duration of the motion signal.

61. An electronic device, comprising:
a processor; and
a memory, configured to store a computer program, the computer program comprising computer readable instructions, which when executed by the processor, cause the processor to
obtain a motion signal sensed by a motion sensor associated with a device, the motion signal representing a motion of the device caused by an external object; and
identify an external object category of the external object that is a cause of the motion, using a motion identification algorithm, based on the motion signal, wherein the motion identification algorithm is based on a plurality of motion models corresponding to a plurality of external object categories, respectively.

62. The electronic device of claim 61, further comprising the motion sensor.

63. The electronic device of claim 62, further comprising at least one of:
a camera configured to capture an image near the device as an additional signal; or
a microphone configured to acquire a sound near the device as an additional signal.
